(19) United States
(12) Patent Application Publication
(10) Pub. No.: US 2026/0177793 A1
(43) Pub. Date: Jun. 25, 2026

(54) VARIABLE MAGNIFICATION OPTICAL SYSTEM AND IMAGING APPARATUS

(71) Applicant: FUJIFILM Corporation, Tokyo (JP)

(72) Inventor: Masaru YONEZAWA, Saitama (JP)

(73) Assignee: FUJIFILM Corporation, Tokyo (JP)

(21) Appl. No.: 19/423,941

(22) Filed: Dec. 17, 2025

(30) Foreign Application Priority Data
Dec. 25, 2024 (JP) 2024-229272

(51) Int. Cl. G02B 15/14; G02B 15/163

(52) U.S. Cl. CPC G02B 15/145121; G02B 15/163

(57) ABSTRACT

A variable magnification optical system consists of, in order from an object side to an image side, a first lens group having positive refractive power, a second lens group having negative refractive power, an intermediate group, and a final lens group having positive refractive power. A front-side intermediate lens group having positive refractive power is disposed closest to the object side in the intermediate group, and a rear-side intermediate lens group having negative refractive power is disposed closest to the image side in the intermediate group. During changing magnification from a wide angle end to a telephoto end, the first lens group moves to the object side. The variable magnification optical system satisfies a predetermined conditional expression.

### CROSS-REFERENCE TO RELATED APPLICATIONS

This application claims priority from Japanese Patent Application No. 2024-229272, filed on Dec. 25, 2024, the entire disclosure of which is incorporated herein by reference.

### BACKGROUND

### Technical Field

The disclosed technology relates to a variable magnification optical system and an imaging apparatus.

### Related Art

In the related art, an optical system according to JP2015-210371A has been proposed as an optical system that can be applied to an imaging apparatus such as a digital camera.

### SUMMARY

There is demand for a variable magnification optical system that is reduced in size with a high zoom ratio and that has favorable optical performance. There is also demand for a wide angle. A level of such demand is increasing year by year.

The present disclosure provides a variable magnification optical system that has favorable optical performance while achieving size reduction, a wide angle, and a high zoom ratio, and an imaging apparatus comprising the variable magnification optical system.

According to an aspect of the present disclosure, there is provided a variable magnification optical system consisting of, in order from an object side to an image side, a first lens group having positive refractive power, a second lens group having negative refractive power, an intermediate group consisting of a plurality of lens groups, and a final lens group having positive refractive power, in which a front-side intermediate lens group having positive refractive power is disposed closest to the object side in the intermediate group, a rear-side intermediate lens group having negative refractive power is disposed closest to the image side in the intermediate group, during changing magnification from a wide angle end to a telephoto end, the first lens group moves to the object side, and all spacings between adjacent lens groups change, and Conditional Expression (1) is satisfied, which is represented by

$$- 0.25 < f 2 / f 1 < - 0.05 . \qquad ( 1 )$$

A focal length of the first lens group is denoted by f1. A focal length of the second lens group is denoted by f2.

It is preferable that the first lens group consists of, in order from the object side to the image side, a negative meniscus lens of which a surface on the object side is a convex surface, a positive lens, and a positive lens.

It is preferable that a positive lens of which a surface on the image side is a convex surface is disposed closest to the image side in the final lens group.

In a case where a difference between a distance on an optical axis from a lens surface closest to the object side in the first lens group to an image plane at the wide angle end and a distance on the optical axis from the lens surface closest to the object side in the first lens group to the image plane at the telephoto end is denoted by ZDD1, and a focal length of the variable magnification optical system at the wide angle end is denoted by fw, it is preferable that the variable magnification optical system of the aspect satisfies Conditional Expression (2) represented by

$$2 < ZDD 1 / fw < 15. \qquad ( 2 )$$

In a configuration in which a negative meniscus lens of which a surface on the object side is a convex surface is disposed closest to the object side in the first lens group, in a case where a refractive index at a d line for the negative meniscus lens closest to the object side in the first lens group is denoted by Nd1, it is preferable that the variable magnification optical system of the aspect satisfies Conditional Expression (3) represented by

$$1.7 < Nd 1 < 2.4 . \qquad ( 3 )$$

In a case where a refractive index at a d line for the positive lens closest to the image side in the final lens group is denoted by NdEr, it is preferable that the variable magnification optical system of the aspect satisfies Conditional Expression (4) represented by

$$1.43 < NdEr < 1.85 . \qquad ( 4 )$$

In a case where a sum of a distance on an optical axis from a lens surface closest to the object side in the first lens group to a lens surface closest to the image side in the final lens group and a back focus of the variable magnification optical system as an air conversion distance at the wide angle end is denoted by TLw, and the back focus of the variable magnification optical system as the air conversion distance at the wide angle end is denoted by Bfw, it is preferable that the variable magnification optical system of the aspect satisfies Conditional Expression (5) represented by

$$4 < TLw / Bfw < 12. \qquad ( 5 )$$

In a case where a sum of a distance on an optical axis from a lens surface closest to the object side in the first lens group to a lens surface closest to the image side in the final lens group and a back focus of the variable magnification optical system as an air conversion distance at the telephoto end is denoted by TLt, and a focal length of the variable magnification optical system at the telephoto end is denoted by ft, it is preferable that the variable magnification optical system satisfies Conditional Expression (6) represented by

$$0.85 < TLt / f t < 3. \qquad ( 6 )$$

In a case where a focal length of the final lens group is denoted by fE, it is preferable that the variable magnification optical system of the aspect satisfies Conditional Expression (7) represented by

$$0.9 < f 1 / fE < 3. \qquad ( 7 )$$

In a case where a sum of a distance on an optical axis from a lens surface closest to the object side in the first lens group to a lens surface closest to the image side in the final lens group and a back focus of the variable magnification optical system as an air conversion distance at the wide angle end is denoted by TLw, and a focal length of the variable magnification optical system at the wide angle end is denoted by fw, it is preferable that the variable magnification optical system of the aspect satisfies Conditional Expression (8) represented by

$$6 < TLw / fw < 10. \qquad ( 8 )$$

In a case where a refractive index at a d line for a positive lens closest to the object side among positive lenses included in the first lens group is denoted by Nd1p, it is preferable that the variable magnification optical system of the aspect satisfies Conditional Expression (9) represented by

$$1.43 < Nd 1 p < 1.72 . \qquad ( 9 )$$

It is preferable that the positive lens closest to the image side in the final lens group is a meniscus lens.

During changing the magnification, the final lens group may be configured to remain stationary with respect to an image plane.

In a case where a focal length of the rear-side intermediate lens group is denoted by fMr, and a focal length of the final lens group is denoted by fE, it is preferable that the variable magnification optical system of the aspect satisfies Conditional Expression (10) represented by

$$- 1.5 < fMr / fE < - 0.1 . \qquad ( 10 )$$

In a case where a back focus of the variable magnification optical system as an air conversion distance at the wide angle end is denoted by Bfw, and a focal length of the variable magnification optical system at the wide angle end is denoted by fw, it is preferable that the variable magnification optical system of the aspect satisfies Conditional Expression (11) represented by

$$0.8 < Bfw / fw < 2. \qquad ( 11 )$$

In a case where a focal length of the variable magnification optical system at the telephoto end is denoted by ft, and a focal length of the variable magnification optical system at the wide angle end is denoted by fw, it is preferable that the variable magnification optical system of the aspect satisfies Conditional Expression (12) represented by

$$4 < f t / fw < 30. \qquad ( 12 )$$

In a case where a focal length of the front-side intermediate lens group is denoted by fMf, it is preferable that the variable magnification optical system of the aspect satisfies Conditional Expression (13) represented by

$$- 3 < fMf / f 2 < - 0.7 . \qquad ( 13 )$$

In a case where a combined lateral magnification of all groups on the image side with respect to the second lens group in a state where an infinite distance object is in focus at the telephoto end is denoted by βT2R, and a combined lateral magnification of all groups on the image side with respect to the second lens group in a state where the infinite distance object is in focus at the wide angle end is denoted by βW2R, it is preferable that the variable magnification optical system of the aspect satisfies Conditional Expression (14) represented by

$$1.5 < β T 2 R / β W 2 R < 5. \qquad ( 14 )$$

In a case where a lateral magnification of the second lens group in a state where an infinite distance object is in focus at the telephoto end is denoted by βT2, and a lateral magnification of the second lens group in a state where the infinite distance object is in focus at the wide angle end is denoted by βW2, it is preferable that the variable magnification optical system of the aspect satisfies Conditional Expression (15) represented by

$$1.5 < β T 2 / β W 2 < 6. \qquad ( 15 )$$

According to another aspect of the present disclosure, there is provided an imaging apparatus comprising the variable magnification optical system of the aspect.

In the present specification, the terms “consist of” and “consisting of” mean that a lens substantially not having refractive power, an optical element other than a lens, such as a stop, a filter, and a cover glass, a mechanism part such as a lens flange, a lens barrel, an imaging element, and a camera shake correction mechanism, and the like may be included in addition to the illustrated constituents.

In the present specification, the term “group having positive refractive power” means that the whole group has positive refractive power. Similarly, the term “group having negative refractive power” means that the whole group has negative refractive power. The terms “lens having positive refractive power” and “positive lens” are synonymous with each other. The terms “lens having negative refractive power” and “negative lens” are synonymous with each other. In the present specification, the terms “lens group” and “focus group” are not limited to being configured to consist of a plurality of lenses and may be configured to consist of only one lens.

The number of lenses in the present specification is the number of lenses as constituents. For example, the number of lenses in a cemented lens in which a plurality of single lenses formed of different materials are cemented is represented by the number of single lenses constituting the cemented lens. A compound aspherical lens (that is, a lens functioning as one aspherical lens as a whole composed of a spherical lens and an aspherical surface-shaped film formed on the spherical lens that are integrated with each other) is not regarded as a cemented lens and is treated as one lens. Unless otherwise specified, a sign of refractive power and a surface shape related to a lens including an aspherical surface in a paraxial region are used.

In the present specification, the term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in a state where the infinite distance object is in focus.

The terms “d line”, “C line”, “F line”, and “g line” according to the present specification are bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

According to the present disclosure, a variable magnification optical system that has favorable optical performance while achieving size reduction, a wide angle, and a high zoom ratio, and an imaging apparatus comprising the variable magnification optical system can be provided.

### BRIEF DESCRIPTION OF THE DRAWINGS

FIG. 1 is a diagram corresponding to a variable magnification optical system of Example 1 and showing a cross-sectional view of a configuration and a moving trajectory of a variable magnification optical system according to one embodiment.

FIG. 2 is a cross-sectional view of the configuration of the variable magnification optical system in FIG. 1 for describing symbols of conditional expressions.

FIG. 3 is each aberration diagram of the variable magnification optical system of Example 1.

FIG. 4 is a diagram showing a cross-sectional view of a configuration and a moving trajectory of a variable magnification optical system of Example 2.

FIG. 5 is each aberration diagram of the variable magnification optical system of Example 2.

FIG. 6 is a diagram showing a cross-sectional view of a configuration and a moving trajectory of a variable magnification optical system of Example 3.

FIG. 7 is each aberration diagram of the variable magnification optical system of Example 3.

FIG. 8 is a diagram showing a cross-sectional view of a configuration and a moving trajectory of a variable magnification optical system of Example 4.

FIG. 9 is each aberration diagram of the variable magnification optical system of Example 4.

FIG. 10 is a diagram showing a cross-sectional view of a configuration and a moving trajectory of a variable magnification optical system of Example 5.

FIG. 11 is each aberration diagram of the variable magnification optical system of Example 5.

FIG. 12 is a diagram showing a cross-sectional view of a configuration and a moving trajectory of a variable magnification optical system of Example 6.

FIG. 13 is each aberration diagram of the variable magnification optical system of Example 6.

FIG. 14 is a diagram showing a cross-sectional view of a configuration and a moving trajectory of a variable magnification optical system of Example 7.

FIG. 15 is each aberration diagram of the variable magnification optical system of Example 7.

FIG. 16 is a diagram showing a cross-sectional view of a configuration and a moving trajectory of a variable magnification optical system of Example 8.

FIG. 17 is each aberration diagram of the variable magnification optical system of Example 8.

FIG. 18 is a diagram showing a cross-sectional view of a configuration and a moving trajectory of a variable magnification optical system of Example 9.

FIG. 19 is each aberration diagram of the variable magnification optical system of Example 9.

FIG. 20 is a diagram showing a cross-sectional view of a configuration and a moving trajectory of a variable magnification optical system of Example 10.

FIG. 21 is each aberration diagram of the variable magnification optical system of Example 10.

FIG. 22 is a diagram showing a cross-sectional view of a configuration and a moving trajectory of a variable magnification optical system of Example 11.

FIG. 23 is each aberration diagram of the variable magnification optical system of Example 11.

FIG. 24 is a perspective view of a front surface side of an imaging apparatus according to one embodiment.

FIG. 25 is a perspective view of a rear surface side of the imaging apparatus shown in FIG. 24.

### DETAILED DESCRIPTION

Hereinafter, embodiments of the present disclosure will be described with reference to the drawings.

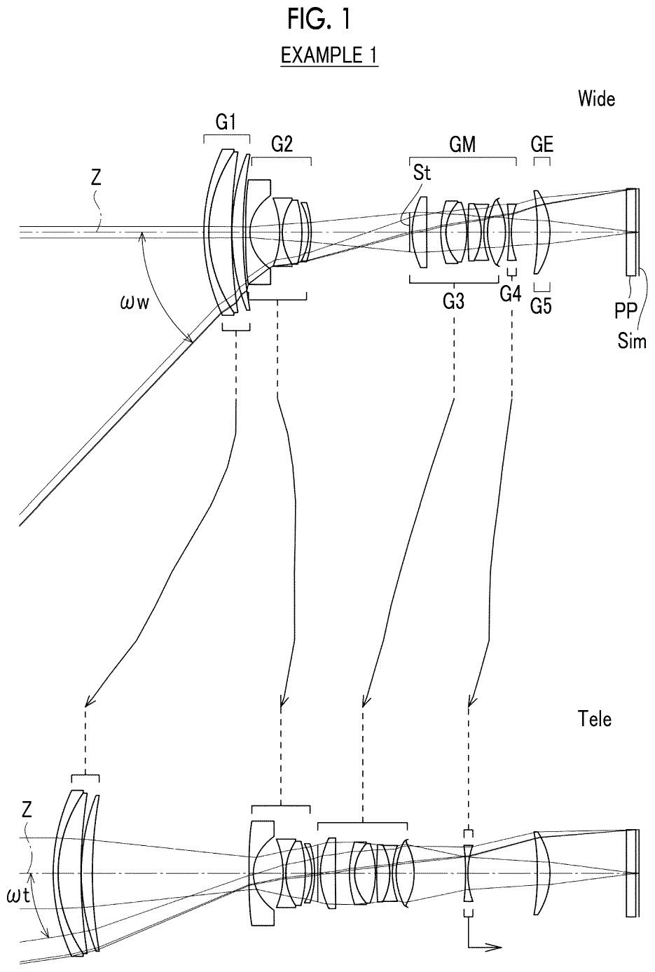

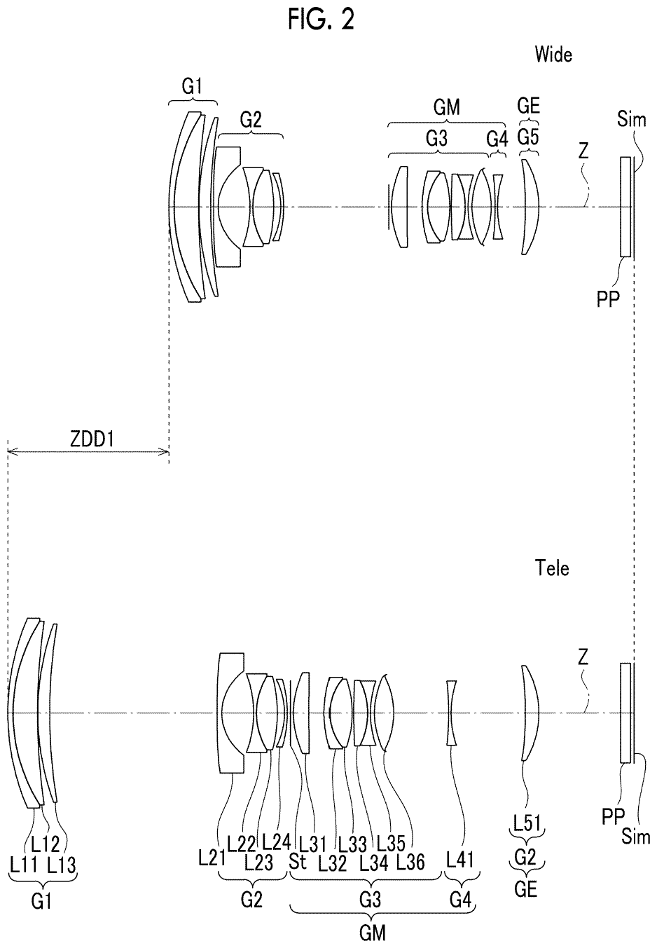

FIG. 1 shows a cross-sectional view of a configuration and luminous fluxes and a moving trajectory of a variable magnification optical system according to one embodiment of the present disclosure. As the luminous fluxes, FIG. 1 shows an on-axis luminous flux and a luminous flux of a maximum half angle of view ωw at a wide angle end and an on-axis luminous flux and a luminous flux of a maximum half angle of view ωt at a telephoto end. FIG. 2 shows a cross-sectional view of the configuration of the variable magnification optical system in FIG. 1. In FIGS. 1 and 2, a wide angle end state is shown in an upper part labeled “Wide”, and a telephoto end state is shown in a lower part labeled “Tele”. In FIGS. 1 and 2, a left side is an object side, a right side is an image side, and a state where an infinite distance object is in focus is shown. Examples shown in FIGS. 1 and 2 correspond to a variable magnification optical system of Example 1 described later. Hereinafter, FIG. 1 will be mainly referred to for description, and FIG. 2 will be referred to, as necessary.

FIG. 1 shows an example in which a parallel flat plate-shaped optical member PP is disposed between the variable magnification optical system and an image plane Sim, assuming application of the variable magnification optical system to an imaging apparatus. The optical member PP is a member that is assumed to be various filters and/or a cover glass or the like. The various filters include a low-pass filter, an infrared cut filter, and/or a filter or the like that cuts a specific wavelength range. The optical member PP is a member not having refractive power. The imaging apparatus can also be configured without the optical member PP.

The variable magnification optical system of the present disclosure consists of, in order from the object side to the image side along an optical axis Z, a first lens group G1 having positive refractive power, a second lens group G2 having negative refractive power, an intermediate group GM consisting of a plurality of lens groups, and a final lens group GE having positive refractive power. A front-side intermediate lens group having positive refractive power is disposed closest to the object side in the intermediate group GM. A rear-side intermediate lens group having negative refractive power is disposed closest to the image side in the intermediate group GM. During changing magnification from the wide angle end to the telephoto end, the first lens group G1 moves to the object side, and all spacings between adjacent lens groups change.

Forming the first lens group G1 closest to the object side as a lens group having positive refractive power can reduce a total length and provides an advantage in achieving compatibility between size reduction and a high zoom ratio. Setting the refractive power of the first lens group G1 to be positive can reduce a height of an incident ray on the second lens group G2 and thus, provides an advantage in reducing fluctuation of aberration during changing the magnification. Disposing the second lens group G2 having negative refractive power provides an advantage in achieving a wide angle. Disposing the front-side intermediate lens group having positive refractive power adjacent to the second lens group G2 on the image side provides an advantage in achieving size reduction. Including both of positive and negative lens groups such as the front-side intermediate lens group having positive refractive power and the rear-side intermediate lens group having negative refractive power in the intermediate group GM provides an advantage in correcting various types of aberration. Setting the refractive power of the final lens group GE closest to the image side to be positive can further reduce an incidence angle of an off-axis chief ray on the image plane Sim. Moving the first lens group G1 to the object side during changing the magnification provides an advantage in achieving a high zoom ratio. Changing the spacings between the plurality of lens groups during changing the magnification provides an advantage in reducing various types of aberration in the whole magnification range.

In the present specification, one lens group is a group of which a spacing with respect to an adjacent group in an optical axis direction changes during changing the magnification. During changing the magnification, a spacing between adjacent lenses does not change in one lens group. That is, the term “lens group” means a part constituting the variable magnification optical system and including at least one lens divided by an air spacing that changes during changing the magnification. During changing the magnification, each lens group moves or remains stationary in lens group units. The term “lens group” may include a constituent, other than a lens, not having refractive power, for example, an aperture stop St.

For example, the variable magnification optical system in FIG. 1 consists of, in order from the object side to the image side, the first lens group G1, the second lens group G2, a third lens group G3, a fourth lens group G4, and a fifth lens group G5. In the example in FIG. 1, the intermediate group GM consists of the third lens group G3 and the fourth lens group G4, and the final lens group GE consists of the fifth lens group G5. In the example in FIG. 1, the front-side intermediate lens group corresponds to the third lens group G3, and the rear-side intermediate lens group corresponds to the fourth lens group G4. To avoid complication of the drawing, some reference numerals are not illustrated in the lower part of FIG. 1.

For example, as shown in FIG. 2, each group of the variable magnification optical system in FIG. 1 is configured as follows. The first lens group G1 consists of, in order from the object side to the image side, three lenses including lenses L11 to L13. The second lens group G2 consists of, in order from the object side to the image side, four lenses including lenses L21 to L24. The third lens group G3 consists of, in order from the object side to the image side, the aperture stop St and six lenses including lenses L31 to L36. The fourth lens group G4 consists of one lens that is a lens L41. The fifth lens group G5 consists of one lens that is a lens L51. The aperture stop St shown in FIGS. 1 and 2 does not show a size or a shape and shows a position in the optical axis direction.

In the example in FIG. 1, during changing the magnification, the fifth lens group G5 remains stationary with respect to the image plane Sim, and the first lens group G1, the second lens group G2, the third lens group G3, and the fourth lens group G4 move along the optical axis Z by changing a spacing with respect to an adjacent lens group. In FIG. 1, a schematic moving trajectory during changing the magnification from the wide angle end to the telephoto end is shown between the upper part and the lower part by solid line arrows for each lens group that moves during changing the magnification.

The example in FIG. 1 is merely an example, and various modifications can be made to the variable magnification optical system of the present disclosure without departing from the gist of the disclosed technology. For example, the number of lens groups included in the intermediate group GM may be different from that of the example in FIG. 1. The number and configurations of lenses included in each lens group may be different from those of the example in FIG. 1. Behavior of each lens group during changing the magnification may be different from that of the example in FIG. 1. While FIG. 1 shows an example in which the variable magnification optical system is a zoom lens, the variable magnification optical system of the present disclosure may be a varifocal lens.

It is preferable that a negative meniscus lens of which a surface on the object side is a convex surface is disposed closest to the object side in the first lens group G1. Disposing a negative meniscus lens of which a surface on the object side is a convex surface closest to the object side facilitates aberration correction in a case where a focal length of the variable magnification optical system at the wide angle end is reduced. The first lens group G1 may be configured to consist of, in order from the object side to the image side, a negative meniscus lens of which a surface on the object side is a convex surface, a positive lens, and a positive lens. Doing so facilitates aberration correction in the first lens group G1 and provides an advantage in reducing fluctuation of aberration during changing the magnification. The above effect is achieved by disposing a negative meniscus lens of which a surface on the object side is a convex surface closest to the object side.

The second lens group G2 may be configured to consist of, for example, three negative lenses and one positive lens. It may be configured to dispose a negative lens closest to the image side in the second lens group G2. In this case, the negative lens closest to the image side in the second lens group G2 may be a meniscus lens of which a surface on the image side is a convex surface.

The intermediate group GM may be configured to consist of, as in the example in FIG. 1, the front-side intermediate lens group and the rear-side intermediate lens group. Configuring the intermediate group GM to consist of two lens groups can simplify a drive mechanism for the lens group.

Alternatively, the intermediate group GM may be configured to consist of the front-side intermediate lens group, a lens group having positive refractive power, and the rear-side intermediate lens group. Configuring the intermediate group GM to consist of three lens groups provides an advantage in reducing fluctuation of aberration during changing the magnification. In addition, positive refractive power can be distributed, and this provides an advantage in achieving, particularly, a high zoom ratio.

In a case where the intermediate group GM consists of the front-side intermediate lens group, the lens group having positive refractive power, and the rear-side intermediate lens group, the final lens group GE may be configured to move during changing the magnification. Configuring the intermediate group GM to consist of three lens groups can achieve the above effect. Furthermore, moving the final lens group GE as well during changing the magnification provides an advantage in reducing fluctuation of aberration during changing the magnification.

The intermediate group GM may be configured to consist of the front-side intermediate lens group, a lens group having negative refractive power, and the rear-side intermediate lens group. Configuring the intermediate group GM to consist of three lens groups provides an advantage in reducing fluctuation of aberration during changing the magnification. In addition, an increase in the positive refractive power of the front-side intermediate lens group is facilitated, and this provides an advantage in securing a back focus in a case where a wide angle is achieved.

The aperture stop St may be configured to be disposed closest to the object side in the intermediate group GM. Doing so can relatively reduce a distance between the first lens group G1 and the aperture stop St and thus, can reduce a distance from a lens surface closest to the object side to an entrance pupil position. This provides an advantage in reducing a size of the first lens group G1.

The rear-side intermediate lens group may be configured to consist of one negative lens. Doing so provides an advantage in reducing a weight of the optical system.

Alternatively, the rear-side intermediate lens group may be configured to consist of one cemented lens in which a positive lens and a negative lens are cemented. Doing so provides an advantage in reducing fluctuation of chromatic aberration during changing the magnification.

It may be configured to dispose a positive lens closest to the object side in the rear-side intermediate lens group. Doing so provides an advantage in correcting spherical aberration at the telephoto end.

It may be configured to dispose a negative lens closest to the image side in the rear-side intermediate lens group. Doing so provides an advantage in correcting field curvature.

It is preferable that a positive lens of which a surface on the image side is a convex surface is disposed closest to the image side in the final lens group GE. Doing so facilitates aberration correction in the final lens group GE and thus, provides an advantage in reducing fluctuation of aberration during changing the magnification. It is preferable that the positive lens closest to the image side in the final lens group GE is a meniscus lens. Doing so facilitates aberration correction in the final lens group GE and thus, provides an advantage in reducing fluctuation of aberration during changing the magnification.

The final lens group GE may be configured to consist of one or two lenses. Doing so provides an advantage in achieving size reduction.

The final lens group GE may be configured to consist of a positive lens of which a surface on the image side in a paraxial region is a convex surface and that includes at least one lens surface having an aspherical surface shape. Configuring the final lens group GE with such an aspherical lens provides an advantage in reducing aberration and can simplify a configuration of the final lens group GE.

During changing the magnification, the final lens group GE may be configured to remain stationary with respect to the image plane Sim. Doing so can simplify a drive mechanism for the lens.

Alternatively, during changing the magnification, the final lens group GE may be configured to move. Doing so provides an advantage in reducing fluctuation of aberration during changing the magnification.

The variable magnification optical system may be configured to include a focus group that moves along the optical axis Z during focusing. In general, a moving amount of the focus group during focusing at the telephoto end is larger than that at the wide angle end. In addition, in the lens group configuration of the variable magnification optical system of the present disclosure, a spacing between the rear-side intermediate lens group and the final lens group GE is likely to be large. From the above circumstances, it is preferable that the focus group is configured to consist of the rear-side intermediate lens group to secure a sufficient spacing for moving the focus group. During focusing from the infinite distance object to a nearby object, it is preferable that the rear-side intermediate lens group moves to the image side. Such a configuration can reduce a size of the focus group and thus, provides an advantage in reducing a size of the whole lens system and an advantage in reducing breathing. In a case where the focus group is composed of a lens group other than the rear-side intermediate lens group in the same lens group configuration as the variable magnification optical system of the present disclosure, it is required to expand a spacing between lens groups for focusing. This may be disadvantageous in reducing the size of the whole lens system.

In the example in FIG. 1, the focus group consists of the fourth lens group G4 that is the rear-side intermediate lens group. In the lower part of FIG. 1, a bracket and an arrow in a left-to-right direction are given below a lens corresponding to the focus group. The arrow in the left-to-right direction shows a direction in which the focus group moves during focusing from the infinite distance object to the nearby object. While the focus group functions in the whole magnification range including the wide angle end state, the arrow is given in only the lower part of FIG. 1 to avoid complication. The above illustration method related to the focus group also applies to the drawings of other examples.

In the variable magnification optical system of the present disclosure, it is preferable that a maximum full angle of view at the wide angle end is 80 degrees or more. Doing so can implement a variable magnification optical system having a larger angle of view at the wide angle end. The maximum full angle of view is twice the maximum half angle of view. The maximum full angle of view at the wide angle end is more preferably 85 degrees or more, further preferably 90 degrees or more, and further preferably 95 degrees or more.

Next, preferable configurations of the variable magnification optical system of the present disclosure related to the conditional expressions will be described. In the following description of the conditional expressions, to avoid redundancy, duplicate descriptions of symbols will be omitted using the same symbols for the same definitions. Hereinafter, to avoid redundancy, the “variable magnification optical system of the present disclosure” will be simply referred to as the “variable magnification optical system”.

In a case where a focal length of the first lens group G1 is denoted by f1, and a focal length of the second lens group G2 is denoted by f2, it is preferable that the variable magnification optical system satisfies Conditional Expression (1). Ensuring that a corresponding value of Conditional Expression (1) is not less than or equal to its lower limit value prevents an excessive increase in the refractive power of the first lens group G1 and thus, provides an advantage in reducing aberration occurring in the first lens group G1, particularly spherical aberration at the telephoto end. Ensuring that the corresponding value of Conditional Expression (1) is not greater than or equal to its upper limit value prevents an excessive decrease in the refractive power of the first lens group G1 and thus, can reduce the height of the ray incident on the second lens group G2. This provides an advantage in reducing the size of the optical system.

$$- 0.25 < f 2 / f 1 < - 0.05 \qquad ( 1 )$$

To obtain more favorable characteristics, the lower limit value of Conditional Expression (1) is more preferably −0.22, further preferably −0.2, further preferably −0.18, further preferably −0.17, further preferably −0.16, and further preferably −0.15. To obtain more favorable characteristics, the upper limit value of Conditional Expression (1) is more preferably −0.07, further preferably −0.09, further preferably −0.1, further preferably −0.115, further preferably −0.12, and further preferably −0.125.

It is preferable that the variable magnification optical system satisfies Conditional Expression (2). A difference between a distance on the optical axis from a lens surface closest to the object side in the first lens group G1 to the image plane Sim at the wide angle end and a distance on the optical axis from a lens surface closest to the object side in the first lens group G1 to the image plane Sim at the telephoto end is denoted by ZDD1. The focal length of the variable magnification optical system at the wide angle end is denoted by fw. For example, FIG. 2 shows the difference ZDD1. The variable magnification optical system shown in FIGS. 1 and 2 is a zoom lens. Thus, as shown in FIG. 2, a position of the image plane Sim does not change even in a case where the magnification is changed. Ensuring that a corresponding value of Conditional Expression (2) is not less than or equal to its lower limit value provides an advantage in achieving compatibility between a wide angle and a high zoom ratio. Ensuring that the corresponding value of Conditional Expression (2) is not greater than or equal to its upper limit value can reduce a moving amount of the first lens group G1 during changing the magnification and thus, provides an advantage in reducing the size of the optical system.

$$2 < ZDD 1 / fw < 15 \qquad ( 2 )$$

To obtain more favorable characteristics, the lower limit value of Conditional Expression (2) is more preferably 2.4, further preferably 2.7, further preferably 3, further preferably 3.1, further preferably 3.2, and further preferably 3.3. To obtain more favorable characteristics, the upper limit value of Conditional Expression (2) is more preferably 13, further preferably 11, further preferably 10, further preferably 9, further preferably 8, and further preferably 7.5.

In a configuration in which a negative meniscus lens of which a surface on the object side is a convex surface is disposed closest to the object side in the first lens group G1, it is preferable that the variable magnification optical system satisfies Conditional Expression (3). A refractive index at a d line with respect to the negative meniscus lens closest to the object side in the first lens group G1 is denoted by Nd1. Ensuring that a corresponding value of Conditional Expression (3) is not less than or equal to its lower limit value provides an advantage in reducing aberration occurring in the first lens group G1, particularly spherical aberration at the telephoto end and astigmatism at the wide angle end. Ensuring that the corresponding value of Conditional Expression (3) is not greater than or equal to its upper limit value enables selection of a material having high transmittance.

$$1. 7 < Nd 1 < 2.4 \qquad ( 3 )$$

To obtain more favorable characteristics, the lower limit value of Conditional Expression (3) is more preferably 1.8, further preferably 1.85, further preferably 1.88, further preferably 1.9, further preferably 1.91, and further preferably 1.92. To obtain more favorable characteristics, the upper limit value of Conditional Expression (3) is more preferably 2.35, further preferably 2.3, further preferably 2.2, further preferably 2.15, further preferably 2.1, and further preferably 2.06.

In a configuration in which a positive lens of which a surface on the image side is a convex surface is disposed closest to the image side in the final lens group GE, it is preferable that the variable magnification optical system satisfies Conditional Expression (4). A refractive index at a d line for the positive lens closest to the image side in the final lens group GE is denoted by NdEr. Ensuring that a corresponding value of Conditional Expression (4) is not less than or equal to its lower limit value facilitates securing of a refractive power required for the final lens group GE and thus, provides an advantage in reducing aberration occurring in the final lens group GE. Ensuring that the corresponding value of Conditional Expression (4) is not greater than or equal to its upper limit value prevents an excessive increase in the refractive power of the final lens group GE and thus, provides an advantage in correcting field curvature and distortion.

$$1.43 < NdEr < 1.85 \qquad ( 4 )$$

To obtain more favorable characteristics, the lower limit value of Conditional Expression (4) is more preferably 1.46, further preferably 1.47, further preferably 1.48, further preferably 1.49, and further preferably 1.5. To obtain more favorable characteristics, the upper limit value of Conditional Expression (4) is more preferably 1.75, further preferably 1.7, further preferably 1.65, further preferably 1.62, and further preferably 1.6.

It is preferable that the variable magnification optical system satisfies Conditional Expression (5). A sum of a distance on the optical axis from the lens surface closest to the object side in the first lens group G1 to a lens surface closest to the image side in the final lens group GE and a back focus of the variable magnification optical system as an air conversion distance at the wide angle end is denoted by TLw. The back focus of the variable magnification optical system as the air conversion distance at the wide angle end is denoted by Bfw. Ensuring that a corresponding value of Conditional Expression (5) is not less than or equal to its lower limit value reduces the back focus and thus, enables the final lens group GE to be disposed at a position away from other lens groups. This provides an advantage in correcting field curvature. Ensuring that the corresponding value of Conditional Expression (5) is not greater than or equal to its upper limit value provides an advantage in reducing the size of the optical system at the wide angle end and an advantage in securing the back focus.

$$4 < TLw / Bfw < 12 \qquad ( 5 )$$

To obtain more favorable characteristics, the lower limit value of Conditional Expression (5) is more preferably 4.2 and further preferably 4.8. To obtain more favorable characteristics, the upper limit value of Conditional Expression (5) is more preferably 11 and further preferably 10.

It is preferable that the variable magnification optical system satisfies Conditional Expression (6). A sum of a distance on the optical axis from the lens surface closest to the object side in the first lens group G1 to the lens surface closest to the image side in the final lens group GE and a back focus of the variable magnification optical system as an air conversion distance at the telephoto end is denoted by TLt. A focal length of the variable magnification optical system at the telephoto end is denoted by ft. Ensuring that a corresponding value of Conditional Expression (6) is not less than or equal to its lower limit value provides an advantage in correcting aberration at the telephoto end. Ensuring that the corresponding value of Conditional Expression (6) is not greater than or equal to its upper limit value provides an advantage in reducing the size of the optical system at the telephoto end.

$$0.85 < TLt / ft < 3 \qquad ( 6 )$$

To obtain more favorable characteristics, the lower limit value of Conditional Expression (6) is more preferably 0.89 and further preferably 0.92. To obtain more favorable characteristics, the upper limit value of Conditional Expression (6) is more preferably 2.5 and further preferably 2.3.

In a case where a focal length of the final lens group GE is denoted by fE, it is preferable that the variable magnification optical system satisfies Conditional Expression (7). Ensuring that a corresponding value of Conditional Expression (7) is not less than or equal to its lower limit value prevents an excessive increase in the refractive power of the first lens group G1 and thus, provides an advantage in reducing aberration occurring in the first lens group G1, particularly spherical aberration at the telephoto end. Ensuring that the corresponding value of Conditional Expression (7) is not greater than or equal to its upper limit value prevents an excessive decrease in the refractive power of the first lens group G1 and thus, can reduce the height of the ray incident on the second lens group G2. This provides an advantage in reducing the size of the optical system.

$$0.9 < f 1 / fE < 3 \qquad ( 7 )$$

To obtain more favorable characteristics, the lower limit value of Conditional Expression (7) is more preferably 1, further preferably 1.05, further preferably 1.1, further preferably 1.13, and further preferably 1.15. To obtain more favorable characteristics, the upper limit value of Conditional Expression (7) is more preferably 2.5, further preferably 2.2, further preferably 1.9, further preferably 1.7, and further preferably 1.5.

It is preferable that the variable magnification optical system satisfies Conditional Expression (8). Ensuring that a corresponding value of Conditional Expression (8) is not less than or equal to its lower limit value provides an advantage in achieving a high zoom ratio. Ensuring that the corresponding value of Conditional Expression (8) is not greater than or equal to its upper limit value provides an advantage in reducing the size of the optical system at the wide angle end.

$$6 < TLw / fw < 10 \qquad ( 8 )$$

To obtain more favorable characteristics, the lower limit value of Conditional Expression (8) is more preferably 6.5 and further preferably 7. To obtain more favorable characteristics, the upper limit value of Conditional Expression (8) is more preferably 9.9 and further preferably 9.7.

It is preferable that the variable magnification optical system satisfies Conditional Expression (9). A refractive index at a d line for a positive lens closest to the object side among positive lenses included in the first lens group G1 is denoted by Nd1p. Ensuring that a corresponding value of Conditional Expression (9) is not less than or equal to its lower limit value provides an advantage in reducing, particularly, spherical aberration at the telephoto end and astigmatism at the wide angle end. In general, as a refractive index decreases, a relative density decreases. Thus, ensuring that the corresponding value of Conditional Expression (9) is not greater than or equal to its upper limit value provides an advantage in reducing a weight of the lens. In addition, ensuring that the corresponding value of Conditional Expression (9) is not greater than or equal to its upper limit value facilitates selection of a material having a large Abbe number and thus, provides an advantage in reducing chromatic aberration.

$$1. 43 < ND 1 p < 1.72 \qquad ( 9 )$$

To obtain more favorable characteristics, the lower limit value of Conditional Expression (9) is more preferably 1.48, further preferably 1.5, further preferably 1.52, and further preferably 1.54. To obtain more favorable characteristics, the upper limit value of Conditional Expression (9) is more preferably 1.68, further preferably 1.65, further preferably 1.62, and further preferably 1.6.

In a case where a focal length of the rear-side intermediate lens group is denoted by fMr, it is preferable that the variable magnification optical system satisfies Conditional Expression (10). Ensuring that a corresponding value of Conditional Expression (10) is not less than or equal to its lower limit value prevents an excessive increase in the refractive power of the final lens group GE and thus, facilitates aberration correction in the final lens group GE. This provides an advantage in reducing fluctuation of aberration during changing the magnification. Ensuring that the corresponding value of Conditional Expression (10) is not greater than or equal to its upper limit value prevents an excessive decrease in the refractive power of the final lens group GE and thus, provides an advantage in correcting field curvature and distortion.

$$- 1.5 < fMr / fE < - 0.1 \qquad ( 10 )$$

To obtain more favorable characteristics, the lower limit value of Conditional Expression (10) is more preferably −1.2, further preferably −0.9, further preferably −0.6, further preferably −0.5, and further preferably −0.4. To obtain more favorable characteristics, the upper limit value of Conditional Expression (10) is more preferably −0.2, further preferably −0.22, further preferably −0.24, further preferably −0.26, and further preferably −0.27.

It is preferable that the variable magnification optical system satisfies Conditional Expression (11). Ensuring that a corresponding value of Conditional Expression (11) is not less than or equal to its lower limit value provides an advantage in securing the back focus and an advantage in achieving a wide angle. Ensuring that the corresponding value of Conditional Expression (11) is not greater than or equal to its upper limit value reduces the back focus and thus, enables the final lens group GE to be disposed at a position away from other lens groups. This provides an advantage in correcting field curvature.

$$0.8 < Bfw / fw < 2 \qquad ( 11 )$$

To obtain more favorable characteristics, the lower limit value of Conditional Expression (11) is more preferably 0.85 and further preferably 0.87. To obtain more favorable characteristics, the upper limit value of Conditional Expression (11) is more preferably 1.98 and further preferably 1.95.

It is preferable that the variable magnification optical system satisfies Conditional Expression (12). Ensuring that a corresponding value of Conditional Expression (12) is not less than or equal to its lower limit value can implement a variable magnification optical system with a higher zoom ratio. Ensuring that the corresponding value of Conditional Expression (12) is not greater than or equal to its upper limit value to prevent an excessively high zoom ratio provides an advantage in achieving size reduction and reducing fluctuation of aberration during changing the magnification.

$$4 < ft / fw < 30 \qquad ( 12 )$$

To obtain more favorable characteristics, the lower limit value of Conditional Expression (12) is more preferably 6, further preferably 7, and further preferably 8. To obtain more favorable characteristics, the upper limit value of Conditional Expression (12) is more preferably 20, further preferably 13, and further preferably 10.

In a case where a focal length of the front-side intermediate lens group is denoted by fMf, it is preferable that the variable magnification optical system satisfies Conditional Expression (13). Ensuring that a corresponding value of Conditional Expression (13) is not less than or equal to its lower limit value prevents an excessive increase in the refractive power of the second lens group G2 and thus, provides an advantage in reducing fluctuation of aberration during changing the magnification. Ensuring that the corresponding value of Conditional Expression (13) is not greater than or equal to its upper limit value prevents an excessive decrease in the refractive power of the second lens group G2 and thus, provides an advantage in reducing the size of the optical system and achieving a wide angle.

$$- 3 < fMf / f 2 < - 0.7 \qquad ( 13 )$$

To obtain more favorable characteristics, the lower limit value of Conditional Expression (13) is more preferably −2.8, further preferably −2.3, further preferably −1.9, further preferably −1.7, and further preferably −1.5. To obtain more favorable characteristics, the upper limit value of Conditional Expression (13) is more preferably −0.8, further preferably −0.9, further preferably −1, further preferably −1.05, and further preferably −1.1.

It is preferable that the variable magnification optical system satisfies Conditional Expression (14). A combined lateral magnification of all groups on the image side with respect to the second lens group G2 in a state where the infinite distance object is in focus at the telephoto end is denoted by βT2R. A combined lateral magnification of all groups on the image side with respect to the second lens group G2 in a state where the infinite distance object is in focus at the wide angle end is denoted by βW2R. Ensuring that a corresponding value of Conditional Expression (14) is not less than or equal to its lower limit value provides an advantage in achieving a high zoom ratio. Ensuring that the corresponding value of Conditional Expression (14) is not greater than or equal to its upper limit value provides an advantage in reducing fluctuation of aberration during changing the magnification.

$$5 < β T 2 R / β W 2 R < 5 \qquad ( 14 )$$

To obtain more favorable characteristics, the lower limit value of Conditional Expression (14) is more preferably 1.8, further preferably 2, further preferably 2.2, and further preferably 2.4. To obtain more favorable characteristics, the upper limit value of Conditional Expression (14) is more preferably 4.3, further preferably 4, further preferably 3.8, and further preferably 3.6.

It is preferable that the variable magnification optical system satisfies Conditional Expression (15). A lateral magnification of the second lens group G2 in the state where the infinite distance object is in focus at the telephoto end is denoted by βT2. A lateral magnification of the second lens group G2 in the state where the infinite distance object is in focus at the wide angle end is denoted by βW2. Ensuring that a corresponding value of Conditional Expression (15) is not less than or equal to its lower limit value provides an advantage in achieving a high zoom ratio. Ensuring that the corresponding value of Conditional Expression (15) is not greater than or equal to its upper limit value provides an advantage in reducing fluctuation of aberration during changing the magnification.

$$1.5 < β T 2 / β W 2 < 6 \qquad ( 15 )$$

To obtain more favorable characteristics, the lower limit value of Conditional Expression (15) is more preferably 2, further preferably 2.2, further preferably 2.3, and further preferably 2.4. To obtain more favorable characteristics, the upper limit value of Conditional Expression (15) is more preferably 5.5, further preferably 5.1, further preferably 5, and further preferably 4.9.

In a case where a maximum half angle of view at the wide angle end is denoted by @w, it is preferable that the variable magnification optical system satisfies Conditional Expression (16). Ensuring that a corresponding value of Conditional Expression (16) is not less than or equal to its lower limit value provides an advantage in reducing fluctuation of aberration during changing the magnification. Ensuring that the corresponding value of Conditional Expression (16) is not greater than or equal to its upper limit value provides an advantage in reducing the size of the optical system at the wide angle end.

$$6 < TLw / ( fw \times tan ω w ) < 10 \qquad ( 16 )$$

To obtain more favorable characteristics, the lower limit value of Conditional Expression (16) is more preferably 6.5 and further preferably 7. To obtain more favorable characteristics, the upper limit value of Conditional Expression (16) is more preferably 9.5 and further preferably 8.8.

In a configuration in which the first lens group G1 includes a positive lens and a negative lens, it is preferable that the variable magnification optical system satisfies Conditional Expression (17). An Abbe number based on a d line for a negative lens closest to the object side among negative lenses included in the variable magnification optical system is denoted by νdn. Ensuring that a corresponding value of Conditional Expression (17) is not less than or equal to its lower limit value can reduce insufficiency of the refractive power of the negative lens closest to the object side caused by an excessive increase in a difference between an Abbe number of the positive lens and an Abbe number of the negative lens included in the first lens group G1 and thus, provides an advantage in reducing astigmatism at the wide angle end. Ensuring that the corresponding value of Conditional Expression (17) is not greater than or equal to its upper limit value facilitates securing of the difference between the Abbe number of the positive lens and the Abbe number of the negative lens included in the first lens group G1 and thus, provides an advantage in correcting chromatic aberration of the first lens group G1.

$$17 < v d n < 45 \qquad ( 17 )$$

To obtain more favorable characteristics, the lower limit value of Conditional Expression (17) is more preferably 18, further preferably 19, further preferably 20, and further preferably 20.5. To obtain more favorable characteristics, the upper limit value of Conditional Expression (17) is more preferably 40, further preferably 36, further preferably 30, and further preferably 28.

In a case where an Abbe number based on a d line for a positive lens closest to the image side among positive lenses included in the variable magnification optical system is denoted by νdp, it is preferable that the variable magnification optical system satisfies Conditional Expression (18). Ensuring that a corresponding value of Conditional Expression (18) is not less than or equal to its lower limit value provides an advantage in reducing chromatic aberration occurring in the final lens group GE. Ensuring that the corresponding value of Conditional Expression (18) is not greater than or equal to its upper limit value facilitates selection of a material having a high refractive index for the final lens group GE and thus, provides an advantage in reducing aberration occurring in the final lens group GE.

$$48 < vdp < 78 \qquad ( 18 )$$

To obtain more favorable characteristics, the lower limit value of Conditional Expression (18) is more preferably 58, further preferably 60, further preferably 62, and further preferably 63.5. To obtain more favorable characteristics, the upper limit value of Conditional Expression (18) is more preferably 75, further preferably 71.5, further preferably 68.5, and further preferably 67.5.

The above preferable configurations and available configurations including the configurations related to the conditional expressions can be used in any combination thereof without contradiction and are preferably appropriately selected and adopted in accordance with required specifications.

For example, according to a preferred aspect of the present disclosure, there is provided a variable magnification optical system consisting of, in order from the object side to the image side, the first lens group G1 having positive refractive power, the second lens group G2 having negative refractive power, the intermediate group GM consisting of a plurality of lens groups, and the final lens group GE having positive refractive power, in which the front-side intermediate lens group having positive refractive power is disposed closest to the object side in the intermediate group GM, the rear-side intermediate lens group having negative refractive power is disposed closest to the image side in the intermediate group GM, during changing the magnification from the wide angle end to the telephoto end, the first lens group G1 moves to the object side, and all spacings between adjacent lens groups change, and Conditional Expression (1) is satisfied.

Next, examples of the variable magnification optical system of the present disclosure will be described with reference to the drawings. Reference numerals given to each group in the cross-sectional views of each example are independently used for each example to avoid complication of description and the drawings caused by an increasing number of digits of the reference numerals. Accordingly, a common reference numeral given in the drawings of different examples does not necessarily indicate a common configuration.

### Example 1

A configuration and a moving trajectory of the variable magnification optical system of Example 1 are shown in FIG. 1, and its illustration method and configuration are described above. Thus, duplicate descriptions will be partially omitted. The variable magnification optical system of Example 1 consists of, in order from the object side to the image side, the first lens group G1 having positive refractive power, the second lens group G2 having negative refractive power, the third lens group G3 having positive refractive power, the fourth lens group G4 having negative refractive power, and the fifth lens group G5 having positive refractive power. The intermediate group GM consists of the third lens group G3 and the fourth lens group G4. The final lens group GE consists of the fifth lens group G5.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fourth lens group G4. During focusing from the infinite distance object to the nearby object, the focus group moves to the image side.

For the variable magnification optical system of Example 1, Table 1 shows basic lens data, Table 2 shows specifications and variable surface spacings, and Tables 3A and 3B show aspherical coefficients.

The table of the basic lens data is described as follows. A column of “Sn” shows surface numbers in a case where a surface closest to the object side is set as a first surface, and the number is increased by one at a time to the image side. A column of “R” shows a curvature radius of each surface. A column of “D” shows a surface spacing on the optical axis between each surface and a surface adjacent to each surface on the image side. A column of “Nd” shows a refractive index at a d line for each constituent. A column of “νd” shows an Abbe number based on the d line for each constituent. A column of “Material” shows a material name and a manufacturer company name of each constituent with a period therebetween. The table schematically shows the manufacturer company name as follows. “CDGM” indicates Chengdu Guangming Guangdian Co., Ltd. “NHG” indicates Hubei New Huaguang Information Materials Co., Ltd. “HOYA” indicates HOYA Corporation. “HIKARI” indicates HIKARI GLASS Co., Ltd. “SUMITA” indicates Sumita Optical Industries Ltd. “OHARA” indicates OHARA INC. A column of “ED” shows an effective diameter of each surface.

In the table of the basic lens data, a sign of the curvature radius of a surface having a convex shape facing the object side is positive, and a sign of the curvature radius of a surface having a convex shape facing the image side is negative. The table of the basic lens data also shows the aperture stop St and the optical member PP. A field of the surface number of a surface corresponding to the aperture stop St shows the surface number and a text (St). A value in a lowermost field of the column of D in the table is a spacing between a surface closest to the image side in the table and the image plane Sim. A symbol DD[ ] is used for the variable surface spacings. A surface number on the object side of a spacing is shown in [ ] in the column of the surface spacing.

Table 2 shows a zoom ratio Zr, a focal length f, a back focus Bf as an air conversion distance, an open F-number FNo., a maximum full angle of view 2ω, and the variable surface spacings based on a d line. In a case where the variable magnification optical system is a zoom lens, the zoom ratio is synonymous with a zoom magnification. Here, [°] in a field of 2ω indicates that 2ω is in degree units. Table 2 shows each value in the wide angle end state, a middle focal length state, and the telephoto end state for each of a state where the infinite distance object is in focus, and a state where the nearby object is in focus. In a case where the infinite distance object is in focus, a row of an object distance shows “Infinity”. In a case where the nearby object is in focus, the row of the object distance shows an object distance to the nearby object. In Table 2, “m” in “0.2 m” of the object distance is a meter. The object distance is a distance on the optical axis between an object that is a subject of the variable magnification optical system, and a lens surface closest to the object side in the variable magnification optical system. Here, f and Bf are shown in only the state where the infinite distance object is in focus. In a row of a magnification state, “Wide”, “Middle”, and “Tele” mean the wide angle end state, the intermediate focal length state, and the telephoto end state, respectively.

In the table of the basic lens data, the surface number of an aspherical surface is marked with *, and a field of the curvature radius of the aspherical surface shows a value of a paraxial curvature radius. In Table 3, a column of Sn shows the surface number of the aspherical surface, and columns of KA and Am show numerical values of the aspherical coefficients for each aspherical surface. Here, m in Am is an integer greater than or equal to 3 and varies depending on the surface. For example, m=3, 4, 5, . . . , 16 is established for a sixth surface of Example 1. In the numerical values of the aspherical coefficients in Table 3, “E±n” (n: integer) means “×10^{±n}”. KA and Am are aspherical coefficients in an aspheric equation represented by the following expression.

$$Z d = C \times {h}^{2} / \{ 1 + {( KA \times {C}^{2} \times {h}^{2} )}^{1 / 2} \} + \sum Am \times {h}^{m}$$

where
Zd: a depth of the aspherical surface (a length of a perpendicular line drawn from a point on the aspherical surface at a height h to a plane that is in contact with an aspherical surface apex and that is perpendicular to the optical axis Z),
h: a height (a distance from the optical axis Z to the lens surface),
C: a reciprocal of the paraxial curvature radius,
KA and Am: aspherical coefficients, and
Σ0 in the aspheric equation means a sum total related to m.

In the data of each table, a degree unit is used for angles, and a millimeter unit is used for lengths other than the object distance in the table of the specifications. However, since the optical system can also be proportionally enlarged or proportionally reduced to be used, other appropriate units can also be used. Each table below shows numerical values rounded to predetermined digits.

TABLE 1
Example 1

| Sn | R | D | Nd | νd | Material | ED |
|---|---|---|---|---|---|---|
| 1 | 67.6717 | 1.5000 | 1.92286 | 20.88 | H-ZF62.CDGM | 54 |
| 2 | 48.5915 | 6.9602 | 1.59283 | 68.63 | H-FK69.NHG | 52.22 |
| 3 | 179.5297 | 0.1000 | | | | 51.77 |
| 4 | 73.8225 | 3.3642 | 1.88300 | 40.85 | H-ZLAF68C.CDGM | 50.66 |
| 5 | 153.2337 | DD[5] | | | | 50.13 |
| *6 | −487.9355 | 1.3000 | 1.85135 | 40.10 | M-TAFD305.HOYA | 33.99 |
| *7 | 14.2832 | 9.0835 | | | | 23.46 |
| 8 | −31.3040 | 0.8100 | 1.63930 | 44.83 | J-BAF12.HIKARI | 22.28 |
| 9 | 19.8399 | 5.9391 | 1.80518 | 25.45 | H-ZF7LGT.NHG | 20.87 |
| 10 | −40.8574 | 2.0396 | | | | 20.31 |
| 11 | −20.9641 | 0.8000 | 1.88300 | 40.80 | TAFD30.HOYA | 19 |
| 12 | −33.6314 | DD[12] | | | | 19.27 |
| 13 (St) | ∞ | 0.8000 | | | | 18.51 |
| *14 | 24.5934 | 4.4123 | 1.61820 | 45.32 | K-LCV161.SUMITA | 20 |
| *15 | 700.2823 | 4.3011 | | | | 20.06 |
| 16 | 33.6092 | 1.5687 | 1.88300 | 40.85 | H-ZLAF68C.CDGM | 20.31 |
| 17 | 14.9062 | 6.3300 | 1.53775 | 74.70 | S-FPM3.OHARA | 19.34 |
| 18 | −29.3286 | 0.4219 | | | | 19.38 |
| 19 | 196.4459 | 3.9682 | 1.53775 | 74.70 | S-FPM3.OHARA | 18.61 |
| 20 | −20.6964 | 0.8000 | 1.81600 | 46.59 | J-LASF09A.HIKARI | 18.2 |
| 21 | 27.4332 | 1.1290 | | | | 17.95 |
| *22 | 20.7657 | 5.4907 | 1.49710 | 81.56 | M-FCD1.HOYA | 18.74 |
| *23 | −22.9718 | DD[23] | | | | 18.8 |
| 24 | −85.4501 | 0.7000 | 1.59349 | 67.00 | PCD51.HOYA | 18.02 |
| 25 | 28.3810 | DD[25] | | | | 18.26 |
| *26 | −135.6035 | 3.8618 | 1.59201 | 67.02 | M-PCD51.HOYA | 26.48 |
| 27 | −26.2138 | 23.2963 | | | | 27 |
| 28 | ∞ | 2.8500 | 1.51633 | 64.14 | S-BSL7.OHARA | 28.24 |
| 29 | ∞ | 1.0103 | | | | 28.33 |

TABLE 2
Example 1

| | Object Distance | | | | | |
|---|---|---|---|---|---|---|
| | Infinite | Infinite | Infinite | | | |
| | Distance | Distance | Distance | 0.2 m | 0.2 m | 0.2 m |
| | Magnification State | | | | | |
| | Wide | Middle | Tele | Wide | Middle | Tele |
| Zr | 1.00 | 3.40 | 6.20 | 1.00 | 3.40 | 6.20 |
| f | 13.56 | 46.11 | 84.08 | — | — | — |
| Bf | 26.19 | 26.19 | 26.19 | — | — | — |
| FNo. | 3.60 | 3.60 | 3.65 | 3.61 | 3.63 | 3.98 |
| 2ω [°] | 96.66 | 31.68 | 17.78 | 96.58 | 31.50 | 17.56 |
| DD[5] | 0.8000 | 30.5561 | 47.7622 | 0.8000 | 30.5561 | 47.7622 |
| DD[12] | 29.8140 | 5.4094 | 0.9464 | 29.8140 | 5.4094 | 0.9464 |
| DD[23] | 1.0827 | 13.4563 | 15.6718 | 1.5752 | 17.7917 | 26.7016 |
| DD[25] | 7.9185 | 14.7538 | 21.1567 | 7.4260 | 10.4184 | 10.1269 |

TABLE 3
Example 1

| Sn | 6 | 7 |
|---|---|---|
| KA | 1.000000000000000E+00 | −1.376705570346000E+00 |
| A3 | 0.000000000000000E+00 | 0.000000000000000E+00 |
| A4 | 1.101672033068130E−04 | 1.703456883687010E−04 |
| A5 | −5.799885203678910E−06 | 1.123060852292860E−05 |
| A6 | −2.272343866540490E−06 | −7.500937142354360E−06 |
| A7 | 3.173859874669480E−07 | 1.135733803031830E−06 |
| A8 | −5.073070650186080E−09 | −7.141403265250950E−08 |
| A9 | −1.197719265470320E−09 | −3.909814055363390E−10 |
| A10 | 3.983461010964600E−11 | 8.874593623813510E−11 |
| A11 | 2.547160852804200E−12 | 5.977474250213400E−11 |
| A12 | −1.159618403584240E−13 | −6.885809871375170E−12 |
| A13 | 6.290996297518540E−15 | 8.030024417484710E−14 |
| A14 | −1.006292134538430E−15 | 9.448425822513280E−15 |
| A15 | 5.334132608778930E−17 | 6.729113347682490E−16 |
| A16 | −8.917233142991680E−19 | −5.081179540558120E−17 |
| Sn | 14 | 15 |
| KA | 1.000000000000000E+00 | 1.000000000000000E+00 |
| A4 | −1.234223264638540E−05 | 1.660954418364100E−06 |
| A6 | 1.696528880944810E−07 | 1.677240851925910E−07 |
| A8 | −1.120935304699560E−08 | −1.008034397504640E−08 |
| A10 | 3.573601440271160E−10 | 3.436551300007020E−10 |
| A12 | −6.770735010089400E−12 | −7.218157921918840E−12 |
| A14 | 7.644480895696560E−14 | 9.268307754071960E−14 |
| A16 | −4.987136961442980E−16 | −7.102622476469710E−16 |
| A18 | 1.664871667820630E−18 | 2.948423170341630E−18 |
| A20 | −2.011522099564940E−21 | −5.042090070695860E−21 |

| Sn | 22 | 23 |
|---|---|---|
| KA | 1.000000000000000E+00 | 1.000000000000000E+00 |
| A4 | −3.709252330661130E−05 | −3.414516260644150E−06 |
| A6 | −2.064566845864910E−07 | −4.619946433675630E−07 |
| A8 | 2.304844499385240E−08 | 3.623035995530700E−08 |
| A10 | −1.225763954657630E−09 | −1.765528848128740E−09 |
| A12 | 3.674417988703050E−11 | 5.085979263694790E−11 |
| A14 | −6.595806412237640E−13 | −8.930273807550640E−13 |
| A16 | 7.051994824917690E−15 | 9.390943751335020E−15 |
| A18 | −4.144438920007980E−17 | −5.435226693777110E−17 |
| A20 | 1.033633558644480E−19 | 1.333728192205400E−19 |

| Sn | 26 |
|---|---|
| KA | 1.000000000000000E+00 |
| A4 | −1.298281606879570E−05 |
| A6 | 8.577905634234430E−09 |
| A8 | −1.456351383214400E−12 |
| A10 | −2.758898346154880E−14 |
| A12 | 4.970786590947460E−17 |
| A14 | −7.315855462503640E−20 |
| A16 | 2.241731662786190E−22 |
| A18 | −6.030728322056830E−25 |
| A20 | 7.166202076461670E−28 |

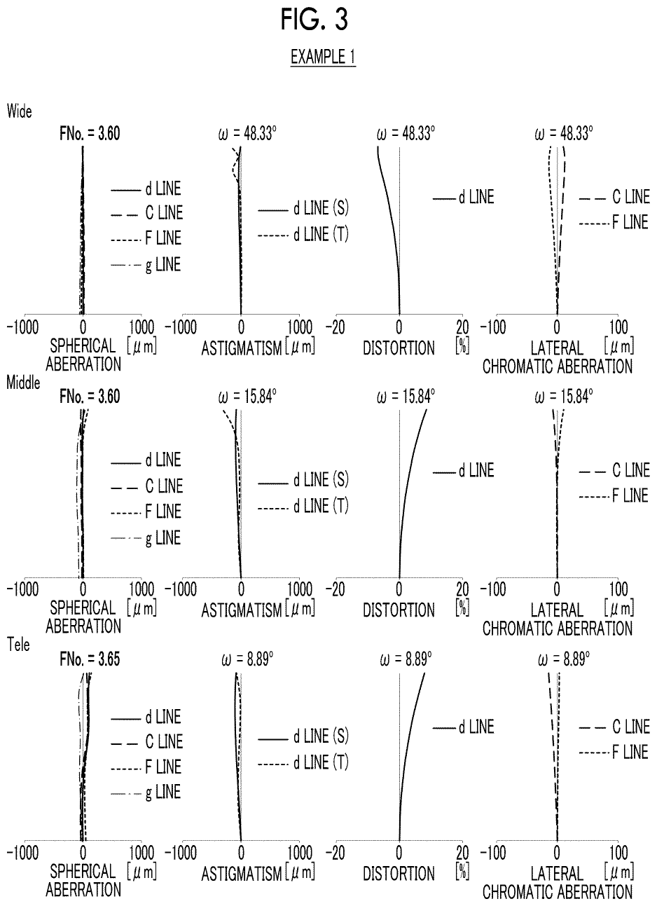

FIG. 3 illustrates each aberration diagram of the variable magnification optical system of Example 1 in the state where the infinite distance object is in focus. FIG. 3 shows spherical aberration, astigmatism, distortion, and lateral chromatic aberration in order from the left. In FIG. 3, an upper part labeled “Wide” shows aberration in the wide angle end state, a middle part labeled “Middle” shows aberration in the middle focal length state, and a lower part labeled “Tele” shows aberration in the telephoto end state. In the spherical aberration diagram, aberration at a d line, a C line, an F line, and a g line is shown by a solid line, a long broken line, a short broken line, and a dot dash line, respectively. In the astigmatism diagram, aberration at a d line in a sagittal direction is shown by a solid line, and aberration at a d line in a tangential direction is shown by a short broken line. In the distortion diagram, aberration at a d line is shown by a solid line. In the lateral chromatic aberration diagram, aberration at a C line and an F line is shown by a long broken line and a short broken line, respectively. In the spherical aberration diagram, a value of the open F-number is shown after FNo.=. In other aberration diagrams, a value of the maximum half angle of view is shown after ω=.

Symbols, meanings, description methods, and illustration methods of each data related to Example 1 are basically the same for the following examples unless otherwise specified. Thus, duplicate descriptions will be omitted below.

### Example 2

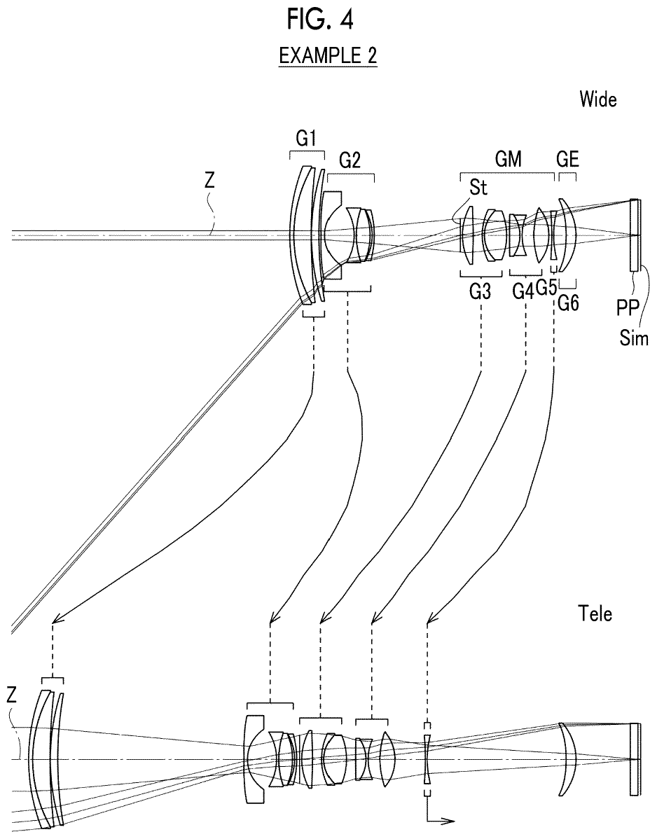

A configuration and a moving trajectory of a variable magnification optical system of Example 2 are shown in FIG. 4. The variable magnification optical system of Example 2 consists of, in order from the object side to the image side, the first lens group G1 having positive refractive power, the second lens group G2 having negative refractive power, the third lens group G3 having positive refractive power, the fourth lens group G4 having negative refractive power, the fifth lens group G5 having negative refractive power, and a sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

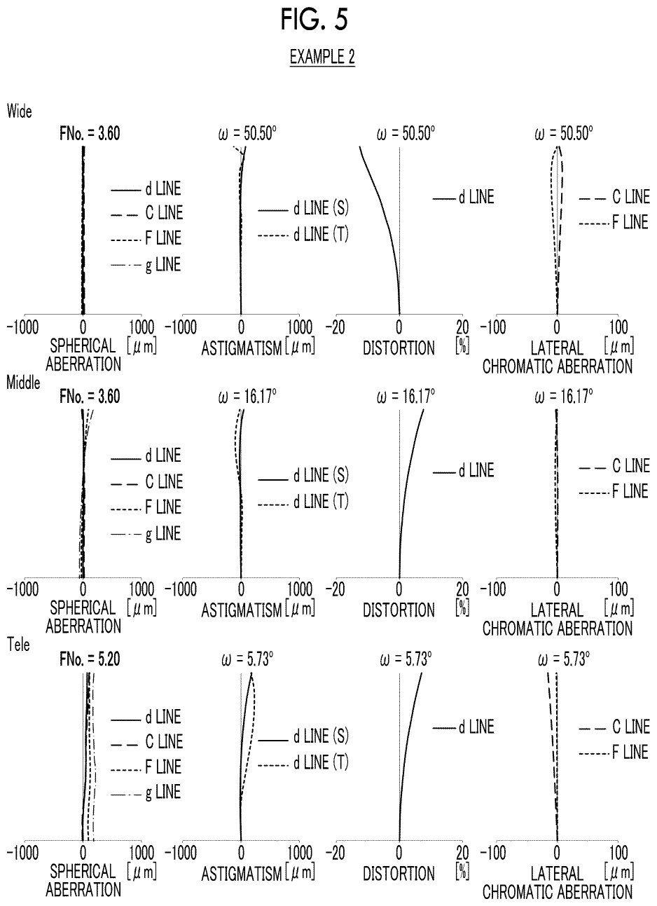

For the variable magnification optical system of Example 2, Table 4 shows basic lens data, Table 5 shows specifications and variable surface spacings, Tables 6A and 6B show aspherical coefficients, and FIG. 5 shows each aberration diagram.

TABLE 4
Example 2

| Sn | R | D | Nd | νd | Material | ED |
|---|---|---|---|---|---|---|
| 1 | 80.0865 | 1.5001 | 1.92286 | 20.88 | H-ZF62.CDGM | 55 |
| 2 | 57.8911 | 6.4679 | 1.59283 | 68.63 | H-FK69.NHG | 53.68 |
| 3 | 246.6291 | 0.1000 | | | | 53.3 |
| 4 | 93.1683 | 2.7647 | 1.90043 | 37.37 | TAFD37A.HOYA | 52.5 |
| 5 | 162.2183 | DD[5] | | | | 52.01 |
| *6 | −102.4536 | 1.3000 | 1.85135 | 40.10 | M-TAFD305.HOYA | 34.85 |
| *7 | 17.4506 | 10.8208 | | | | 23.96 |
| 8 | −21.8345 | 0.8100 | 1.49782 | 82.57 | J-FKH1.HIKARI | 21.75 |
| 9 | 33.9576 | 5.1072 | 1.69894 | 30.05 | H-ZF11.CDGM | 20.71 |
| 10 | −27.7130 | 0.7740 | | | | 20.32 |
| 11 | −21.6083 | 0.8000 | 1.81600 | 46.56 | H-ZLAF69A.CDGM | 20 |
| 12 | −39.6705 | DD[12] | | | | 20.16 |
| 13 (St) | ∞ | 0.8000 | | | | 19.25 |
| *14 | 25.4447 | 3.9991 | 1.66520 | 47.31 | K-LCV93.SUMITA | 20.79 |
| *15 | −129.2463 | 3.3668 | | | | 20.77 |
| 16 | 25.0624 | 0.8002 | 1.91082 | 35.25 | TAFD35L.HOYA | 20.53 |
| 17 | 14.0501 | 8.2767 | 1.49700 | 81.54 | S-FPL51.OHARA | 19.43 |
| 18 | −26.9432 | DD[18] | | | | 19.25 |
| 19 | 909.5340 | 3.8430 | 1.49700 | 81.54 | S-FPL51.OHARA | 16.62 |
| 20 | −15.2080 | 0.8002 | 1.81600 | 46.59 | J-LASF09A.HIKARI | 16.07 |
| 21 | 20.4946 | 4.3795 | | | | 15.79 |
| *22 | 29.4520 | 5.5955 | 1.49710 | 81.56 | M-FCD1.HOYA | 18.4 |
| *23 | −19.1146 | DD[23] | | | | 18.8 |
| 24 | −118.3688 | 0.7000 | 1.59349 | 67.00 | PCD51.HOYA | 19 |
| 25 | 40.7274 | DD[25] | | | | 19.32 |
| *26 | −54.1291 | 3.6809 | 1.59201 | 67.02 | M-PCD51.HOYA | 28.33 |
| 27 | −23.2333 | 20.2000 | | | | 29 |
| 28 | ∞ | 2.8500 | 1.51633 | 64.14 | S-BSL7.OHARA | 28.46 |
| 29 | ∞ | 1.0088 | | | | 28.73 |

TABLE 5
Example 2

| | Object Distance | | | | | |
|---|---|---|---|---|---|---|
| | Infinite | Infinite | Infinite | | | |
| | Distance | Distance | Distance | 0.2 m | 0.2 m | 0.1 m |
| | Magnification State | | | | | |
| | Wide | Middle | Tele | Wide | Middle | Tele |
| Zr | 1.00 | 3.40 | 9.88 | 1.00 | 3.40 | 9.88 |
| f | 13.39 | 45.52 | 132.29 | — | — | — |
| Bf | 23.09 | 23.09 | 23.09 | — | — | — |
| FNo. | 3.60 | 3.60 | 5.20 | 3.60 | 3.57 | 5.37 |
| 2ω [°] | 101.00 | 32.34 | 11.46 | 101.14 | 32.92 | 11.38 |
| DD[5] | 0.8000 | 35.3407 | 69.3687 | 0.8000 | 35.3407 | 69.3687 |
| DD[12] | 32.0400 | 6.5320 | 1.0811 | 32.0400 | 6.5320 | 1.0811 |
| DD[18] | 1.0994 | 2.3551 | 3.4104 | 1.0994 | 2.3551 | 3.4104 |
| DD[23] | 1.0996 | 15.0003 | 11.3245 | 1.9075 | 21.5036 | 32.6253 |
| DD[25] | 4.6323 | 15.2210 | 51.7263 | 3.8244 | 8.7176 | 30.4255 |

TABLE 6A
Example 2

| Sn | 6 | 7 |
|---|---|---|
| KA | 1.000000000000000E+00 | −6.427401749040490E−01 |
| A3 | 0.000000000000000E+00 | 0.000000000000000E+00 |
| A4 | 3.004324429548450E−04 | 3.365741043893680E−04 |
| A5 | −2.457358153302510E−05 | −7.142644422891100E−06 |
| A6 | −4.795936798336870E−06 | −1.625621162560870E−05 |
| A7 | 8.659523547118370E−07 | 4.352873142170260E−06 |
| A8 | −1.394960176622930E−08 | −5.001249526604380E−07 |
| A9 | −6.592923711113930E−09 | −2.214092322044340E−09 |
| A10 | 5.675784921804780E−10 | 8.172829434671540E−09 |
| A11 | −1.320191859982700E−11 | −8.357465253869150E−10 |
| A12 | −8.091916753965800E−14 | −5.620352661318610E−12 |
| A13 | −2.993738327964380E−14 | 7.015331979039480E−12 |
| A14 | 3.332263706546700E−15 | −5.559686168017950E−13 |
| A15 | −1.120560513502040E−16 | 1.877456734557320E−14 |
| A16 | 1.302278973322210E−18 | −2.431099516535870E−16 |

| Sn | 14 | 15 |
|---|---|---|
| KA | 1.000000000000000E+00 | 1.000000000000000E+00 |
| A4 | −4.186778282992690E−06 | 1.113267577652400E−05 |
| A6 | 7.727892966218010E−08 | 1.116490753009270E−07 |
| A8 | −2.911353167793420E−09 | −3.644208333931960E−09 |
| A10 | 9.450014639496530E−11 | 1.026835677084820E−10 |
| A12 | −1.787378256625770E−12 | −1.727063734070670E−12 |
| A14 | 2.048762934047520E−14 | 1.749061148795200E−14 |
| A16 | −1.398887455856130E−16 | −1.028037335265780E−16 |
| A18 | 5.224448545217010E−19 | 3.125335069539180E−19 |
| A20 | −8.372914778557170E−22 | −3.752588759083290E−22 |

TABLE 6B
Example 2

| Sn | 22 | 23 |
|---|---|---|
| KA | 1.000000000000000E+00 | 1.000000000000000E+00 |
| A4 | −3.277848428015210E−05 | −1.533636603599640E−05 |
| A6 | 2.839246417309550E−07 | 1.121342561272600E−07 |
| A8 | −1.261530171831190E−08 | −6.052106890774990E−09 |
| A10 | 3.555487036021230E−10 | 9.019317865302340E−11 |
| A12 | −6.617590876128090E−12 | 2.078089560145310E−13 |
| A14 | 8.104837795243380E−14 | −3.534124534908300E−14 |
| A16 | −6.123130166604530E−16 | 6.258930429237650E−16 |
| A18 | 2.463745929274600E−18 | −4.895607141268310E−18 |
| A20 | −3.447953915379200E−21 | 1.500108298949130E−20 |

| Sn | 26 |
|---|---|
| KA | 1.000000000000000E+00 |
| A4 | −1.857246807210780E−05 |
| A6 | 6.656416271427670E−09 |
| A8 | −5.013550335579610E−11 |
| A10 | 1.325163863499590E−13 |
| A12 | −3.291582491367050E−16 |
| A14 | 4.628308286227020E−19 |
| A16 | −3.006800848984820E−22 |
| A18 | 4.513808320625220E−27 |
| A20 | 1.081140913281910E−28 |

### Example 3

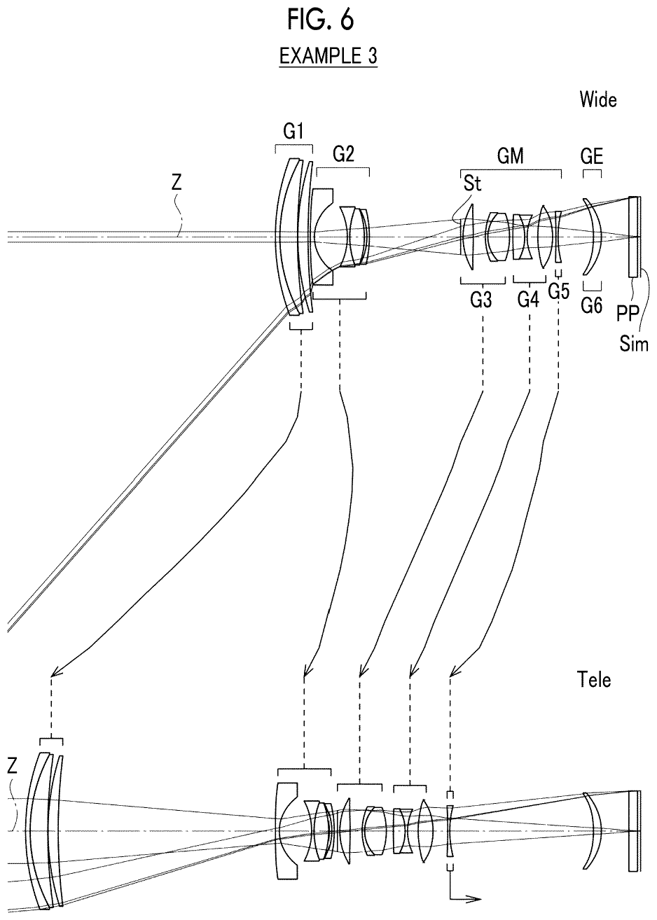

A configuration and a moving trajectory of a variable magnification optical system of Example 3 are shown in FIG. 6. The variable magnification optical system of Example 3 consists of, in order from the object side to the image side, the first lens group G1 having positive refractive power, the second lens group G2 having negative refractive power, the third lens group G3 having positive refractive power, the fourth lens group G4 having negative refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

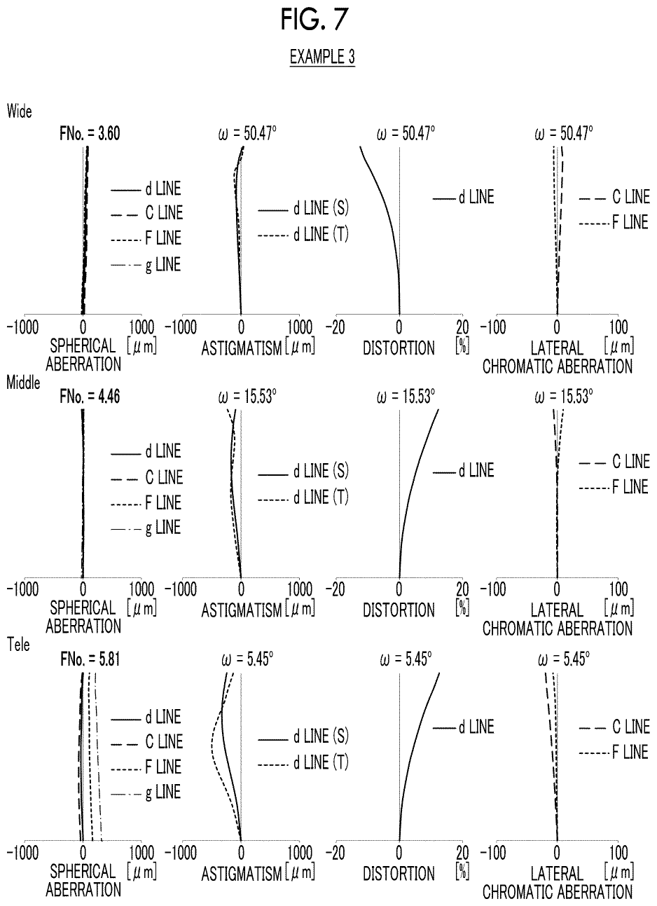

For the variable magnification optical system of Example 3, Table 7 shows basic lens data, Table 8 shows specifications and variable surface spacings, Tables 9A and 9B show aspherical coefficients, and FIG. 7 shows each aberration diagram.

TABLE 7
Example 3

| Sn | R | D | Nd | νd | Material | ED |
|---|---|---|---|---|---|---|
| 1 | 82.4243 | 1.5003 | 1.92286 | 20.88 | H-ZF62.CDGM | 55 |
| 2 | 59.6428 | 5.7851 | 1.59283 | 68.63 | H-FK69.NHG | 53.74 |
| 3 | 197.0349 | 0.1000 | | | | 53.4 |
| 4 | 93.0570 | 3.3581 | 1.81600 | 46.59 | J-LASF09A.HIKARI | 52.81 |
| 5 | 229.6965 | DD[5] | | | | 52.38 |
| *6 | 10000.0000 | 1.3000 | 1.85135 | 40.10 | M-TAFD305.HOYA | 33.74 |
| *7 | 14.8993 | 10.6315 | | | | 23.76 |
| 8 | −23.7761 | 0.8103 | 1.48749 | 70.40 | K-FK5.SUMITA | 21.09 |
| 9 | 29.8579 | 4.7984 | 1.75520 | 27.53 | E-FD4L.HOYA | 19.82 |
| 10 | −30.3261 | 0.8515 | | | | 19.33 |
| 11 | −21.5379 | 0.8000 | 1.90043 | 37.37 | TAFD37A.HOYA | 19 |
| 12 | −42.8298 | DD[12] | | | | 19.11 |
| 13 (St) | ∞ | 0.8000 | | | | 14.44 |
| *14 | 23.3673 | 3.3780 | 1.66955 | 55.43 | K-VC78.SUMITA | 16.08 |
| *15 | −136.5199 | 3.9680 | | | | 16.26 |
| 16 | 22.6031 | 0.8156 | 1.88300 | 40.85 | H-ZLAF68C.CDGM | 17.1 |
| 17 | 12.2332 | 7.1372 | 1.49700 | 81.54 | S-FPL51.OHARA | 16.4 |
| 18 | −24.9740 | DD[18] | | | | 16.58 |
| 19 | 204.7235 | 3.8912 | 1.49700 | 81.54 | S-FPL51.OHARA | 15.6 |
| 20 | −17.2077 | 0.8000 | 1.83481 | 42.72 | TAFD5G.HOYA | 15.21 |
| 21 | 18.6379 | 3.4811 | | | | 15.32 |
| *22 | 32.8576 | 4.8737 | 1.61881 | 63.85 | M-PCD4.HOYA | 18.23 |
| *23 | −24.2333 | DD[23] | | | | 18.8 |
| 24 | −240.4663 | 0.7000 | 1.59349 | 67.00 | PCD51.HOYA | 17.65 |
| 25 | 37.2674 | DD[25] | | | | 17.9 |
| *26 | −37.7475 | 2.6080 | 1.59201 | 67.02 | M-PCD51.HOYA | 26.09 |
| *27 | −19.3932 | 9.0290 | | | | 26.72 |
| 28 | ∞ | 2.8500 | 1.51633 | 64.14 | S-BSL7.OHARA | 28.1 |
| 29 | ∞ | 1.0105 | | | | 28.29 |

TABLE 8
Example 3

| | Object Distance | | | | | |
|---|---|---|---|---|---|---|
| | Infinite | Infinite | Infinite | | | |
| | Distance | Distance | Distance | 0.2 m | 0.2 m | 0.1 m |
| | Magnification State | | | | | |
| | Wide | Middle | Tele | Wide | Middle | Tele |
| Zr | 1.00 | 3.40 | 9.88 | 1.00 | 3.40 | 9.88 |
| f | 13.39 | 45.51 | 132.28 | — | — | — |
| Bf | 11.92 | 11.92 | 11.92 | — | — | — |
| FNo. | 3.60 | 4.46 | 5.81 | 3.59 | 4.42 | 5.81 |
| 2ω [°] | 100.94 | 31.06 | 10.90 | 101.18 | 31.50 | 11.04 |
| DD[5] | 0.8000 | 36.8204 | 71.4230 | 0.8000 | 36.8204 | 71.4230 |
| DD[12] | 30.0055 | 7.2960 | 1.0252 | 30.0055 | 7.2960 | 1.0252 |
| DD[18] | 1.1089 | 1.7039 | 2.3029 | 1.1089 | 1.7039 | 2.3029 |
| DD[23] | 1.0968 | 8.6877 | 4.8221 | 1.9830 | 14.6257 | 26.5404 |
| DD[25] | 11.6507 | 24.3916 | 47.2580 | 10.7645 | 18.4536 | 25.5396 |

TABLE 9A
Example 3

| Sn | 6 | 7 |
|---|---|---|
| KA | 1.000000000000000E+00 | −1.456387336408530E+00 |
| A3 | 0.000000000000000E+00 | 0.000000000000000E+00 |
| A4 | 9.585124796631760E−05 | 1.566276389481900E−04 |
| A5 | −1.069766266249350E−05 | 4.454850224642210E−06 |
| A6 | −7.902336872911150E−07 | −6.574964914222170E−06 |
| A7 | 1.702414561628930E−07 | 1.278445997168950E−06 |
| A8 | 5.788296540041660E−09 | −9.929946457265260E−08 |
| A9 | −2.527602297776100E−09 | −2.919704659885990E−09 |
| A10 | 1.611754535086080E−10 | 1.337948135033010E−09 |
| A11 | −7.300821279278730E−13 | −1.056504231883410E−10 |
| A12 | −3.746606817394190E−13 | 2.379933379348610E−12 |
| A13 | 2.698116194878370E−14 | 5.118072708462380E−14 |
| A14 | −1.395637607270940E−15 | −7.007183647997860E−15 |
| A15 | 4.757386730269450E−17 | 9.446992767475900E−16 |
| A16 | −6.870250895748400E−19 | −4.055205264094960E−17 |

| Sn | 14 | 15 |
|---|---|---|
| KA | 1.040802161352320E+00 | −1.877206078054660E+02 |
| A4 | −8.665983238806420E−06 | 7.353598026410230E−06 |
| A6 | 4.723109371572930E−07 | 2.871638376304220E−07 |
| A8 | −2.175122221317560E−08 | −1.125230461287940E−08 |
| A10 | 6.493626762684110E−10 | 3.591584031368580E−10 |
| A12 | −1.175316986657450E−11 | −6.662514529162190E−12 |
| A14 | 1.316129255623580E−13 | 7.184926903565320E−14 |
| A16 | −9.111778667426540E−16 | −4.428154267762280E−16 |
| A18 | 3.690449308730290E−18 | 1.421642296840080E−18 |
| A20 | −6.918701232632670E−21 | −1.822610200849140E−21 |

TABLE 9B
Example 3

| Sn | 22 | 23 |
|---|---|---|
| KA | 1.615801784855390E+00 | 1.255462531607170E+00 |
| A4 | −2.729126479309730E−05 | −2.705277450245870E−05 |
| A6 | −9.571017009089020E−07 | −2.145197589681110E−08 |
| A8 | 6.340210643227330E−08 | −1.161246188132410E−08 |
| A10 | −2.465824268619710E−09 | 6.962778237432800E−10 |
| A12 | 5.815944853773790E−11 | −2.397868286481060E−11 |
| A14 | −8.453627677476140E−13 | 4.722439308769490E−13 |
| A16 | 7.393578399476320E−15 | −5.328568832360190E−15 |
| A18 | −3.549287439730210E−17 | 3.198328256655890E−17 |
| A20 | 7.224408843809830E−20 | −7.836401004368410E−20 |
| Sn | 26 | 27 |
| KA | 1.973613116925690E+00 | 5.049136890771360E−01 |
| A4 | −4.735156620338020E−05 | |
| A6 | 2.344783932096920E−07 | |
| A8 | −2.131733671576010E−09 | |
| A10 | 1.291806367868560E−11 | |
| A12 | −4.458202063963010E−14 | |
| A14 | 8.388311311241470E−17 | |
| A16 | −8.738432134191440E−20 | |
| A18 | 4.911162105953910E−23 | |
| A20 | −1.349495654272760E−26 | |

### Example 4

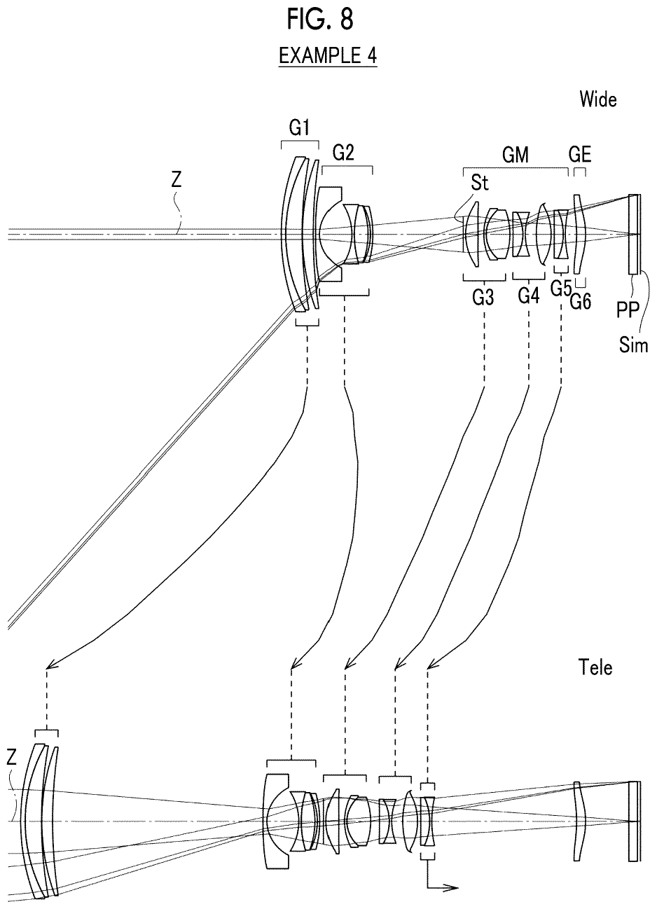

A configuration and a moving trajectory of a variable magnification optical system of Example 4 are shown in FIG. 8. The variable magnification optical system of Example 4 consists of, in order from the object side to the image side, the first lens group G1 having positive refractive power, the second lens group G2 having negative refractive power, the third lens group G3 having positive refractive power, the fourth lens group G4 having negative refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

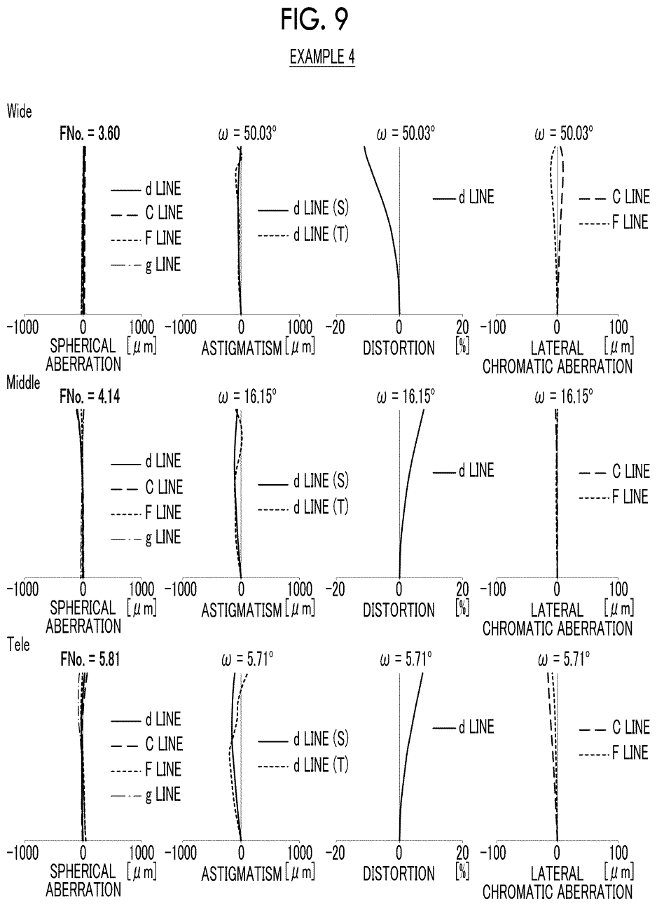

For the variable magnification optical system of Example 4, Table 10 shows basic lens data, Table 11 shows specifications and variable surface spacings, Tables 12A and 12B show aspherical coefficients, and FIG. 9 shows each aberration diagram.

TABLE 10
Example 4

| Sn | R | D | Nd | νd | Material | ED |
|---|---|---|---|---|---|---|
| 1 | 80.8483 | 1.5000 | 1.92286 | 20.88 | H-ZF62.CDGM | 55 |
| 2 | 58.7431 | 5.4346 | 1.59283 | 68.63 | H-FK69.NHG | 53.68 |
| 3 | 159.4971 | 0.1000 | | | | 53.33 |
| 4 | 82.0282 | 3.5876 | 1.81600 | 46.62 | S-LAH59.OHARA | 52.72 |
| 5 | 188.1861 | DD[5] | | | | 52.25 |
| *6 | 1199.7664 | 1.3009 | 1.85135 | 40.10 | M-TAFD305.HOYA | 33.52 |
| *7 | 13.7181 | 10.5811 | | | | 22.76 |
| 8 | −20.9189 | 0.8100 | 1.48749 | 70.39 | H-QK3L.NHG | 21.11 |
| 9 | 38.0144 | 4.5490 | 1.79504 | 28.69 | J-LAFH3HS.HIKARI | 20.34 |
| 10 | −30.5852 | 0.8186 | | | | 20.02 |
| 11 | −22.6867 | 0.7999 | 1.88299 | 40.78 | K-LASFN17.SUMITA | 19.72 |
| 12 | −38.4539 | DD[12] | | | | 19.88 |
| 13 (St) | ∞ | 0.8000 | | | | 16.18 |
| *14 | 20.0112 | 4.1331 | 1.68948 | 31.02 | L-TIM28.OHARA | 18.43 |
| *15 | −397.3423 | 1.9016 | | | | 18.35 |
| 16 | 20.8207 | 0.8000 | 2.00069 | 25.46 | TAFD40-W.HOYA | 18.28 |
| 17 | 11.7553 | 7.8796 | 1.49700 | 81.61 | FCD1.HOYA | 17.13 |
| 18 | −26.1176 | DD[18] | | | | 17.15 |
| 19 | −362.4640 | 3.2610 | 1.57144 | 71.61 | FCD615.HOYA | 15.74 |
| 20 | −16.2930 | 0.8007 | 1.88300 | 39.22 | H-ZLAF68N.CDGM | 15.44 |
| 21 | 21.6442 | 3.6531 | | | | 15.48 |
| *22 | 29.1888 | 4.9279 | 1.59201 | 67.02 | M-PCD51.HOYA | 18.39 |
| *23 | −23.2503 | DD[23] | | | | 18.8 |
| 24 | −815.5896 | 2.9822 | 1.90460 | 21.49 | K-PSFN190.SUMITA | 16.8 |
| 25 | −21.9644 | 0.7100 | 1.87409 | 30.55 | H-ZLAF65.NHG | 16.95 |
| 26 | 40.4599 | DD[26] | | | | 17.3 |
| *27 | −49.2777 | 3.0006 | 1.51633 | 64.06 | L-BSL7.OHARA | 26.46 |
| *28 | −26.2451 | 14.3892 | | | | 26.71 |
| 29 | ∞ | 2.8500 | 1.51633 | 64.14 | S-BSL7.OHARA | 28.13 |
| 30 | ∞ | 1.0227 | | | | 28.34 |

TABLE 11
Example 4

| | Object Distance | | | | | |
|---|---|---|---|---|---|---|
| | Infinite | Infinite | Infinite | | | |
| | Distance | Distance | Distance | 0.2 m | 0.2 m | 0.1 m |
| | Magnification State | | | | | |
| | Wide | Middle | Tele | Wide | Middle | Tele |
| Zr | 1.00 | 3.40 | 9.88 | 1.00 | 3.40 | 9.88 |
| f | 13.39 | 45.53 | 132.33 | — | — | — |
| Bf | 17.29 | 17.29 | 17.29 | — | — | — |
| FNo. | 3.60 | 4.14 | 5.81 | 3.59 | 4.12 | 6.03 |
| 2ω [°] | 100.06 | 32.30 | 11.42 | 100.30 | 32.66 | 11.18 |
| DD[5] | 0.8000 | 36.0660 | 70.0050 | 0.8000 | 36.0660 | 70.0050 |
| DD[12] | 30.0610 | 6.7328 | 1.2177 | 30.0610 | 6.7328 | 1.2177 |
| DD[18] | 1.0595 | 2.2197 | 2.9536 | 1.0595 | 2.2197 | 2.9536 |
| DD[23] | 1.0637 | 6.3275 | 1.0637 | 1.8319 | 11.0511 | 15.5720 |
| DD[26] | 3.7283 | 17.8834 | 48.1528 | 2.9601 | 13.1599 | 33.6445 |

TABLE 12A
Example 4

| Sn | 6 | 7 |
|---|---|---|
| KA | 1.000000000000000E+00 | −1.016603470378290E+00 |
| A3 | 0.000000000000000E+00 | 0.000000000000000E+00 |
| A4 | 1.550624249809110E−04 | 2.255686080978500E−04 |
| A5 | −2.193423928825590E−05 | −2.768409491846980E−06 |
| A6 | −1.660534146347520E−07 | −1.188576796981640E−05 |
| A7 | 1.811917929868810E−07 | 3.851113355681850E−06 |
| A8 | 6.577478292832560E−09 | −6.176669436557860E−07 |
| A9 | −2.751490701884290E−09 | 4.694904361034680E−08 |
| A10 | 1.252455868273670E−10 | −3.619226321262280E−10 |
| A11 | 5.983837115215140E−12 | −3.852080151934710E−11 |
| A12 | −6.416765849191140E−13 | −2.466894983837140E−11 |
| A13 | 1.278877633587010E−14 | 2.403394650094500E−12 |
| A14 | 2.955161412043140E−16 | 3.019566443400040E−14 |
| A15 | −1.169861541018260E−17 | −1.107065029453680E−14 |
| A16 | 5.823354523531370E−20 | 3.524477173002190E−16 |

| Sn | 14 | 15 |
|---|---|---|
| KA | 8.795688734337430E−01 | 6.893735193417890E+02 |
| A4 | −6.279258371716760E−06 | 1.555567515766390E−05 |
| A6 | 2.392307995855420E−07 | 1.962848963556760E−07 |
| A8 | −1.223544586417740E−08 | −8.878641893345150E−09 |
| A10 | 4.366679605400270E−10 | 3.086285689387200E−10 |
| A12 | −9.569732267087820E−12 | −6.249171079868950E−12 |
| A14 | 1.317550656379930E−13 | 7.456715869510910E−14 |
| A16 | −1.121839565909690E−15 | −5.116157412135740E−16 |
| A18 | 5.443292064776830E−18 | 1.822409226243520E−18 |
| A20 | −1.165168565706700E−20 | −2.582906026542930E−21 |

TABLE 12B
Example 4

| Sn | 22 | 23 |
|---|---|---|
| KA | 1.113101207566060E+00 | 6.013008052757660E−01 |
| A4 | −4.326968580087100E−05 | −2.476528966567010E−05 |
| A6 | −5.667949317278980E−08 | 1.873926479991650E−07 |
| A8 | 1.143755544812160E−08 | −1.360416549047870E−08 |
| A10 | −6.443837484982210E−10 | 3.911040092059250E−10 |
| A12 | 1.953292900675190E−11 | −6.797337719326970E−12 |
| A14 | −3.466377865361770E−13 | 6.255685179516760E−14 |
| A16 | 3.687510166523120E−15 | −1.213686441271150E−16 |
| A18 | −2.180179037516090E−17 | −2.408754883961090E−18 |
| A20 | 5.610728729882900E−20 | 1.478911349038470E−20 |
| Sn | 27 | 28 |
| KA | −1.327801481067490E+02 | −3.725847543451660E+00 |
| A4 | −5.492002146026530E−05 | 6.397770974418150E−05 |
| A6 | 1.324748612635430E−07 | −2.088128721329290E−06 |
| A8 | 1.661219048711030E−08 | 4.519906440765680E−08 |
| A10 | −3.345675262109940E−10 | −5.535080220752960E−10 |
| A12 | 3.355192541985100E−12 | 4.090420994134950E−12 |
| A14 | −1.896959940351570E−14 | −1.717890062028470E−14 |
| A16 | 5.725582201236580E−17 | 3.180686756709900E−17 |
| A18 | −7.295392482721430E−20 | 1.195351555498810E−20 |
| A20 | 5.224667627773210E−24 | −9.280768114536240E−23 |

### Example 5

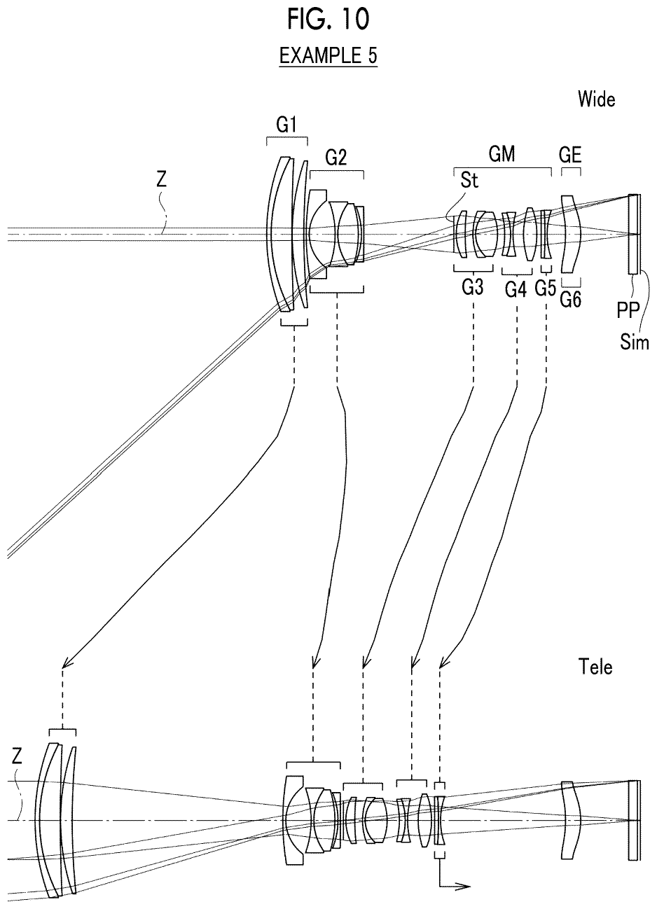

A configuration and a moving trajectory of a variable magnification optical system of Example 5 are shown in FIG. 10. The variable magnification optical system of Example 5 consists of, in order from the object side to the image side, the first lens group G1 having positive refractive power, the second lens group G2 having negative refractive power, the third lens group G3 having positive refractive power, the fourth lens group G4 having negative refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

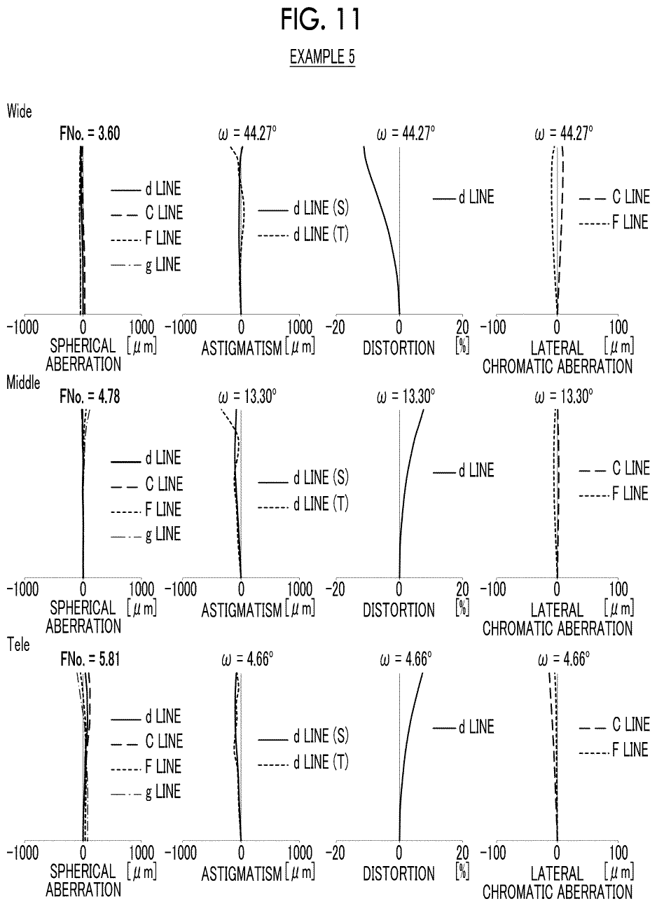

For the variable magnification optical system of Example 5, Table 13 shows basic lens data, Table 14 shows specifications and variable surface spacings, Table 15 shows aspherical coefficients, and FIG. 11 shows each aberration diagram.

TABLE 13
Example 5

| Sn | R | D | Nd | νd | Material | ED |
|---|---|---|---|---|---|---|
| 1 | 82.1978 | 1.5010 | 2.05090 | 26.94 | TAFD65.HOYA | 55 |
| 2 | 61.1470 | 6.8787 | 1.59283 | 68.63 | H-FK69.NHG | 53.79 |
| 3 | 583.3502 | 0.1000 | | | | 53.48 |
| 4 | 86.3149 | 3.8781 | 1.49700 | 81.64 | J-FK01A.HIKARI | 52.27 |
| 5 | 274.8914 | DD[5] | | | | 51.81 |
| 6 | 100.0002 | 0.9991 | 1.88300 | 40.85 | H-ZLAF68C.CDGM | 31.57 |
| 7 | 15.4338 | 8.4168 | | | | 23.78 |
| 8 | −36.0683 | 0.9009 | 1.58912 | 61.24 | H-ZK3A.NHG | 23 |
| 9 | 19.6718 | 6.8025 | 1.90366 | 31.31 | H-ZLAF75A.CDGM | 21.74 |
| 10 | −38.4010 | 1.0370 | | | | 20.96 |
| 11 | −27.5709 | 0.7991 | 1.88300 | 40.85 | H-ZLAF68C.CDGM | 19.72 |
| 12 | −763.6766 | DD[12] | | | | 19.37 |
| 13 (St) | ∞ | 0.8000 | | | | 13.9 |
| *14 | 19.5348 | 2.9530 | 1.80610 | 40.73 | MC-NBFD130.HOYA | 15.62 |
| *15 | 86.7715 | 2.5715 | | | | 15.53 |
| 16 | 23.2858 | 0.8903 | 1.90525 | 35.04 | S-LAH93.OHARA | 15.9 |
| 17 | 10.9667 | 7.2889 | 1.49700 | 81.61 | FCD1.HOYA | 15.18 |
| 18 | −21.2582 | DD[18] | | | | 15.57 |
| 19 | −32.2063 | 1.9720 | 1.49700 | 81.61 | FCD1.HOYA | 14.86 |
| 20 | −23.1382 | 0.7991 | 1.80440 | 39.61 | J-LASF013.HIKARI | 14.96 |
| 21 | 32.5512 | 3.4895 | | | | 15.46 |
| *22 | 27.4554 | 4.4209 | 1.61881 | 63.85 | M-PCD4.HOYA | 18.5 |
| *23 | −31.2961 | DD[23] | | | | 18.8 |
| 24 | −1083.4324 | 1.2438 | 1.92286 | 20.88 | E-FDS1.HOYA | 16.8 |
| 25 | −147.2767 | 0.7100 | 1.51680 | 64.20 | BSC7.HOYA | 16.9 |
| 26 | 26.4369 | DD[26] | | | | 17.11 |
| *27 | −41.6667 | 5.0406 | 1.51633 | 64.06 | L-BSL7.OHARA | 25.94 |
| *28 | −24.1557 | 15.9662 | | | | 26.53 |
| 29 | ∞ | 2.8500 | 1.51633 | 64.14 | S-BSL7.OHARA | 28.19 |
| 30 | ∞ | 1.0197 | | | | 28.36 |

TABLE 14
Example 5

| | Object Distance | | | | | |
|---|---|---|---|---|---|---|
| | Infinite | Infinite | Infinite | | | |
| | Distance | Distance | Distance | 0.2 m | 0.2 m | 0.2 m |
| | Magnification State | | | | | |
| | Wide | Middle | Tele | Wide | Middle | Tele |
| Zr | 1.00 | 3.40 | 9.88 | 1.00 | 3.40 | 9.88 |
| f | 16.42 | 55.81 | 162.22 | — | — | — |
| Bf | 18.86 | 18.86 | 18.86 | — | — | — |
| FNo. | 3.60 | 4.78 | 5.81 | 3.59 | 4.75 | 5.74 |
| 2ω [°] | 88.54 | 26.60 | 9.32 | 88.72 | 26.76 | 9.42 |
| DD[5] | 0.8000 | 36.0660 | 70.0050 | 0.8000 | 36.0660 | 70.0050 |
| DD[12] | 29.9327 | 8.0530 | 1.0260 | 29.9327 | 8.0530 | 1.0260 |
| DD[18] | 2.3848 | 3.2762 | 4.0529 | 2.3848 | 3.2762 | 4.0529 |
| DD[23] | 1.4640 | 7.0020 | 1.0717 | 2.5080 | 13.9996 | 31.6388 |
| DD[26] | 6.1340 | 20.8852 | 41.5558 | 5.0900 | 13.8876 | 10.9887 |

TABLE 15
Example 5

| Sn | 14 | 15 |
|---|---|---|
| KA | 1.203893660642230E+00 | −1.811190062981670E+02 |
| A4 | 1.303638521127190E−06 | 5.868088804145740E−05 |
| A6 | 2.312689943185910E−07 | −8.231217704960350E−08 |
| A8 | −4.199824591220180E−09 | −1.212869316907970E−08 |
| A10 | −3.386565548635630E−10 | 6.960532916768070E−10 |
| A12 | 2.647832577895920E−11 | −2.172226414743740E−11 |
| A14 | −8.464747460609510E−13 | 3.989705684135270E−13 |
| A16 | 1.429965032010210E−14 | −4.296971092153730E−15 |
| A18 | −1.257499899769070E−16 | 2.398163744049610E−17 |
| A20 | 4.514428216981080E−19 | −5.248072174448660E−20 |

| Sn | 22 | 23 |
|---|---|---|
| KA | 6.105420459901940E−01 | 1.762983370192660E+00 |
| A4 | −3.494463912010990E−05 | −1.233742218088120E−05 |
| A6 | −5.679631370265060E−07 | −4.572142933918770E−07 |
| A8 | 4.206535454549010E−08 | 3.183185847651250E−08 |
| A10 | −1.794595159534110E−09 | −1.482917647691940E−09 |
| A12 | 4.876682200437390E−11 | 4.236806349883430E−11 |
| A14 | −8.446269917096970E−13 | −7.450371264889660E−13 |
| A16 | 8.987514207855550E−15 | 7.808815897350350E−15 |
| A18 | −5.270086236624170E−17 | −4.413604864159670E−17 |
| A20 | 1.292283454917110E−19 | 1.029817548960470E−19 |
| Sn | 27 | 28 |
| KA | −3.032738578155470E+01 | −2.598118103457180E+00 |
| A4 | −3.338945340100540E−05 | −2.136944050922860E−06 |
| A6 | −5.604600574902120E−07 | −3.442363684757760E−07 |
| A8 | 2.937416580320300E−08 | 7.515354393596960E−09 |
| A10 | −5.455800899549880E−10 | −2.285832419376580E−11 |
| A12 | 6.122920017750670E−12 | −7.836314635507410E−13 |
| A14 | −4.272176544224450E−14 | 1.230014121552680E−14 |
| A16 | 1.790712776826820E−16 | −8.211735351850890E−17 |
| A18 | −4.086927423027480E−19 | 2.698003173404720E−19 |
| A20 | 3.850514859224320E−22 | −3.554084524676970E−22 |

### Example 6

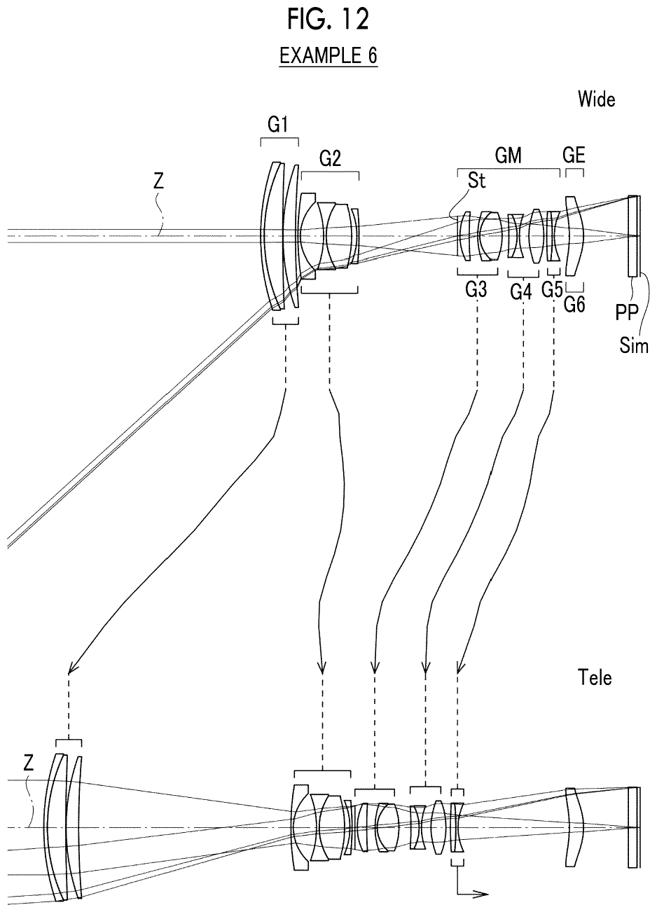

A configuration and a moving trajectory of a variable magnification optical system of Example 6 are shown in FIG. 12. The variable magnification optical system of Example 6 consists of, in order from the object side to the image side, the first lens group G1 having positive refractive power, the second lens group G2 having negative refractive power, the third lens group G3 having positive refractive power, the fourth lens group G4 having negative refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

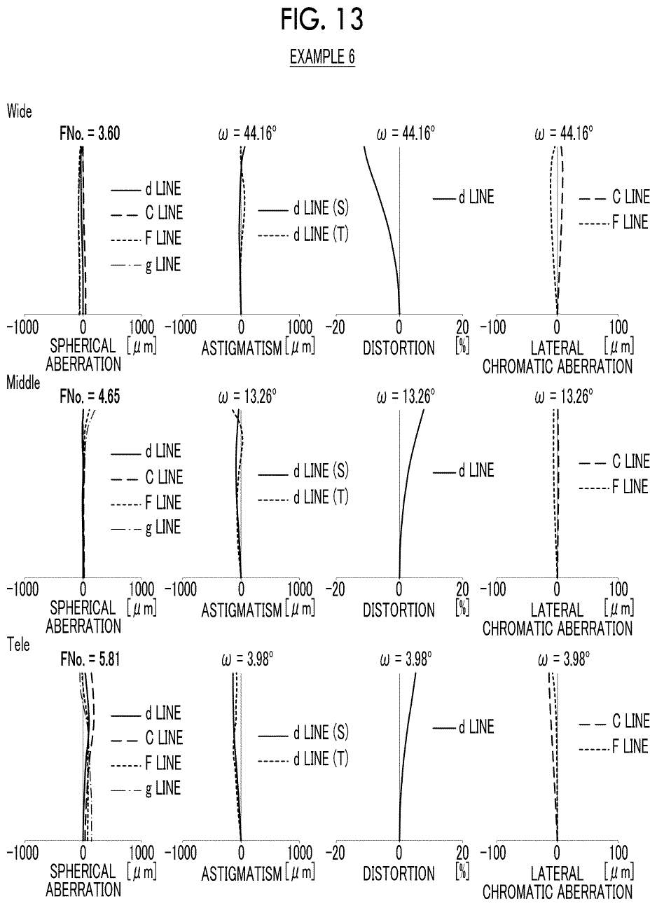

For the variable magnification optical system of Example 6, Table 16 shows basic lens data, Table 17 shows specifications and variable surface spacings, Table 18 shows aspherical coefficients, and FIG. 13 shows each aberration diagram.

TABLE 16
Example 6

| Sn | R | D | Nd | νd | Material | ED |
|---|---|---|---|---|---|---|
| 1 | 86.5941 | 1.2000 | 2.05090 | 26.94 | TAFD65.HOYA | 52 |
| 2 | 64.1033 | 6.0816 | 1.55032 | 75.50 | FCD705.HOYA | 51.13 |
| 3 | 630.3162 | 0.1000 | | | | 50.89 |
| 4 | 80.5825 | 4.1402 | 1.56907 | 71.30 | H-ZPK7.CDGM | 50.02 |
| 5 | 313.8325 | DD[5] | | | | 49.58 |
| 6 | 100.0005 | 0.8000 | 2.00100 | 29.13 | H-ZLAF82.NHG | 30.09 |
| 7 | 17.0406 | 7.6753 | | | | 23.96 |
| 8 | −34.4819 | 0.8840 | 1.59282 | 68.62 | FCD515.HOYA | 23.37 |
| 9 | 21.7948 | 8.3914 | 1.88252 | 27.00 | H-ZLAF86.NHG | 22.28 |
| 10 | −40.5701 | 1.7422 | | | | 20.98 |
| 11 | −25.5414 | 0.7000 | 1.88299 | 40.78 | H-ZLAF68A.NHG | 19.17 |
| 12 | −106.1855 | DD[12] | | | | 19.06 |
| 13 (St) | ∞ | 0.8020 | | | | 15.46 |
| *14 | 20.2834 | 3.0994 | 1.79063 | 44.98 | Q-LASFH12S.HIKARI | 17 |
| *15 | 249.8603 | 2.7685 | | | | 16.89 |
| 16 | 27.0896 | 0.7012 | 1.83400 | 37.21 | S-LAH60V.OHARA | 17.09 |
| 17 | 11.2326 | 7.1827 | 1.52841 | 76.45 | S-FPM4.OHARA | 16.33 |
| 18 | −23.7331 | DD[18] | | | | 16.52 |
| 19 | −96.9527 | 2.6985 | 1.52841 | 76.45 | S-FPM4.OHARA | 15.12 |
| 20 | −17.4830 | 0.7705 | 1.87070 | 40.73 | TAFD32.HOYA | 14.96 |
| 21 | 21.8930 | 3.1425 | | | | 15.25 |
| *22 | 23.4202 | 4.9198 | 1.61881 | 63.85 | M-PCD4.HOYA | 18.5 |
| *23 | −30.7803 | DD[23] | | | | 18.8 |
| 24 | 143.4008 | 1.8036 | 1.85000 | 27.03 | J-LASFH23.HIKARI | 17.2 |
| 25 | −85.6607 | 0.7100 | 1.67790 | 55.53 | H-LAK5A.NHG | 17.18 |
| 26 | 20.5577 | DD[26] | | | | 17.07 |
| *27 | −41.8663 | 4.6800 | 1.51633 | 64.06 | L-BSL7.OHARA | 26.61 |
| *28 | −23.1910 | 14.8263 | | | | 27.19 |
| 29 | ∞ | 2.8500 | 1.51633 | 64.14 | S-BSL7.OHARA | 28.31 |
| 30 | ∞ | 1.0266 | | | | 28.42 |

TABLE 17
Example 6

| | Object Distance | | | | | |
|---|---|---|---|---|---|---|
| | Infinite | Infinite | Infinite | | | |
| | Distance | Distance | Distance | 0.3 m | 0.2 m | 0.2 m |
| | Magnification State | | | | | |
| | Wide | Middle | Tele | Wide | Middle | Tele |
| Zr | 1.00 | 3.40 | 11.80 | 1.00 | 3.40 | 11.80 |
| f | 16.46 | 55.97 | 194.23 | — | — | — |
| Bf | 17.73 | 17.73 | 17.73 | — | — | — |
| FNo. | 3.60 | 4.65 | 5.81 | 3.60 | 4.64 | 5.71 |
| 2ω [°] | 88.32 | 26.52 | 7.96 | 88.42 | 26.52 | 7.92 |
| DD[5] | 0.8000 | 34.6837 | 69.9665 | 0.8000 | 34.6837 | 69.9665 |
| DD[12] | 32.5436 | 10.0903 | 0.9576 | 32.5436 | 10.0903 | 0.9576 |
| DD[18] | 2.2399 | 3.1313 | 3.9800 | 2.2399 | 3.1313 | 3.9800 |
| DD[23] | 0.9835 | 6.5215 | 1.5178 | 1.6720 | 11.1564 | 29.7109 |
| DD[26] | 4.9642 | 17.3248 | 36.6007 | 4.2757 | 12.6899 | 8.4076 |

TABLE 18
Example 6

| Sn | 14 | 15 |
|---|---|---|
| KA | 1.238974812410030E+00 | 4.686908730246670E+02 |
| A4 | −1.761281330789420E−06 | 2.071130573716540E−05 |
| A6 | 4.192306198473430E−07 | 4.538427106345280E−07 |
| A8 | −2.182404461556410E−08 | −2.613976868211350E−08 |
| A10 | 7.400208754991660E−10 | 1.041158590460740E−09 |
| A12 | −1.426423837004530E−11 | −2.511088872999110E−11 |
| A14 | 1.464417917801040E−13 | 3.667551839644180E−13 |
| A16 | −5.742436395831280E−16 | −3.160065107062230E−15 |
| A18 | −1.894408776124000E−18 | 1.440848092843100E−17 |
| A20 | 1.645718197495950E−20 | −2.641489966049600E−20 |

| Sn | 22 | 23 |
|---|---|---|
| KA | 7.051688176069260E−01 | 1.363246163138780E+00 |
| A4 | −3.776455717793680E−05 | −2.120854455232420E−05 |
| A6 | −3.304592735913300E−07 | 1.449581499676370E−07 |
| A8 | 1.882727104369260E−08 | −2.212535235709190E−08 |
| A10 | −3.618275134268290E−10 | 1.248629112318340E−09 |
| A12 | −5.181575054967420E−12 | −4.153229368623460E−11 |
| A14 | 3.574362431833230E−13 | 8.179835378493940E−13 |
| A16 | −6.458600487959870E−15 | −9.353959389244870E−15 |
| A18 | 5.251298198195060E−17 | 5.715376530008630E−17 |
| A20 | −1.627318861542710E−19 | −1.418484737406370E−19 |
| Sn | 27 | 28 |
| KA | −3.169901557809100E+01 | −1.429619919377900E+00 |
| A4 | −2.495018742486150E−05 | 1.323873331659280E−05 |
| A6 | −3.382285541099710E−07 | −4.056433136217970E−07 |
| A8 | 2.170506343314170E−08 | 9.305607052904290E−09 |
| A10 | −3.946123132803380E−10 | −7.463514773054560E−11 |
| A12 | 4.197318299831160E−12 | −3.381596267276780E−16 |
| A14 | −2.753737797502720E−14 | 5.090752722796100E−15 |
| A16 | 1.076605112928100E−16 | −4.260786845958050E−17 |
| A18 | −2.257206510103140E−19 | 1.515473471416730E−19 |
| A20 | 1.897169694882880E−22 | −2.064991088595540E−22 |

### Example 7

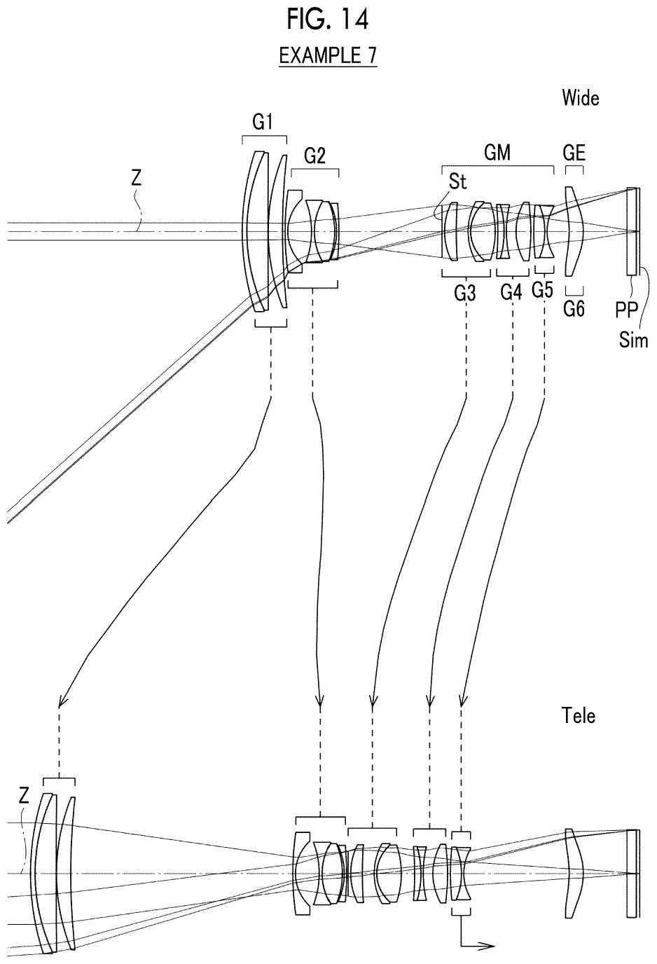

A configuration and a moving trajectory of a variable magnification optical system of Example 7 are shown in FIG. 14. The variable magnification optical system of Example 7 consists of, in order from the object side to the image side, the first lens group G1 having positive refractive power, the second lens group G2 having negative refractive power, the third lens group G3 having positive refractive power, the fourth lens group G4 having positive refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

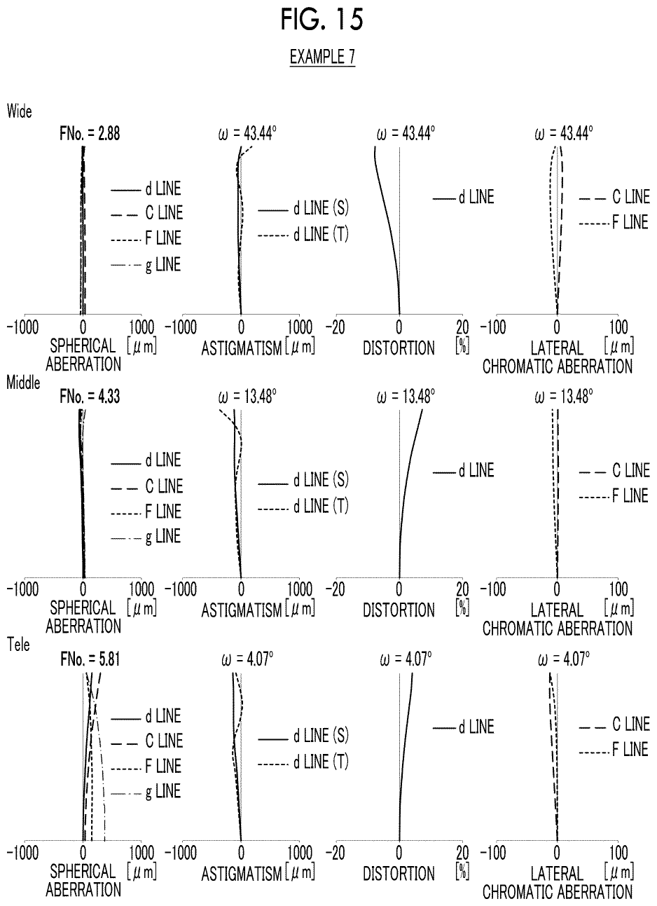

For the variable magnification optical system of Example 7, Table 19 shows basic lens data, Table 20 shows specifications and variable surface spacings, Table 21 shows aspherical coefficients, and FIG. 15 shows each aberration diagram.

TABLE 19
Example 7

| Sn | R | D | Nd | νd | Material | ED |
|---|---|---|---|---|---|---|
| 1 | 88.6414 | 1.4000 | 2.05090 | 26.94 | TAFD65.HOYA | 52 |
| 2 | 64.3106 | 6.4128 | 1.57144 | 71.61 | FCD615.HOYA | 51.06 |
| 3 | 2593.8909 | 0.1000 | | | | 50.82 |
| 4 | 70.6602 | 4.3351 | 1.49700 | 81.54 | S-FPL51.OHARA | 49.56 |
| 5 | 233.4294 | DD[5] | | | | 49.07 |
| 6 | 100.0008 | 0.7991 | 1.95375 | 32.28 | H-ZLAF89LA.CDGM | 26.8 |
| 7 | 14.9920 | 7.2371 | | | | 21.18 |
| 8 | −29.9968 | 0.8800 | 1.59282 | 68.62 | FCD515.HOYA | 20.31 |
| 9 | 20.5898 | 5.9992 | 1.85013 | 30.06 | H-ZLAF76.CDGM | 19.45 |
| 10 | −27.1642 | 0.5762 | | | | 18.91 |
| 11 | −22.9230 | 0.6991 | 1.88300 | 40.76 | S-LAH58.OHARA | 18.21 |
| 12 | −116.5091 | DD[12] | | | | 18.31 |
| 13 (St) | ∞ | 0.8002 | | | | 16.97 |
| *14 | 22.6968 | 3.5452 | 1.68948 | 31.02 | L-TIM28.OHARA | 18.8 |
| *15 | 210.8652 | 3.6000 | | | | 18.71 |
| 16 | 21.1626 | 0.7794 | 2.00069 | 25.46 | TAFD40-W.HOYA | 19.42 |
| 17 | 12.5967 | 7.4658 | 1.55032 | 75.50 | FCD705.HOYA | 18.41 |
| 18 | −30.9523 | DD[18] | | | | 18.48 |
| 19 | −113.5898 | 1.9242 | 1.55032 | 75.50 | FCD705.HOYA | 17.51 |
| 20 | −33.3917 | 0.7000 | 1.90043 | 37.37 | TAFD37A.HOYA | 17.36 |
| 21 | 40.1292 | 2.9247 | | | | 17.33 |
| *22 | 18.5043 | 4.4870 | 1.59201 | 67.02 | M-PCD51.HOYA | 19.02 |
| *23 | −69.4828 | DD[23] | | | | 18.8 |
| 24 | 93.9203 | 3.3514 | 1.90110 | 27.06 | NBFD27.HOYA | 17.2 |
| 25 | −23.1286 | 0.7100 | 1.88300 | 40.76 | S-LAH58.OHARA | 16.95 |
| 26 | 16.8412 | DD[26] | | | | 16.11 |
| *27 | −41.6665 | 4.3186 | 1.51633 | 64.06 | L-BSL7.OHARA | 26.63 |
| *28 | −21.9665 | 13.3060 | | | | 27.2 |
| 29 | ∞ | 2.8500 | 1.51633 | 64.14 | S-BSL7.OHARA | 28.3 |
| 30 | ∞ | 1.0342 | | | | 28.42 |

TABLE 20
Example 7

| | Object Distance | | | | | |
|---|---|---|---|---|---|---|
| | Infinite | Infinite | Infinite | | | |
| | Distance | Distance | Distance | 0.3 m | 0.2 m | 0.2 m |
| | Magnification State | | | | | |
| | Wide | Middle | Tele | Wide | Middle | Tele |
| Zr | 1.00 | 3.40 | 11.80 | 1.00 | 3.40 | 11.80 |
| f | 16.25 | 55.25 | 191.77 | — | — | — |
| Bf | 16.22 | 16.22 | 16.22 | — | — | — |
| FNo. | 2.88 | 4.33 | 5.81 | 2.88 | 4.34 | 5.79 |
| 2ω [°] | 86.88 | 26.96 | 8.14 | 86.94 | 26.86 | 7.98 |
| DD[5] | 0.8000 | 34.3835 | 67.6175 | 0.8000 | 34.3835 | 67.6175 |
| DD[12] | 31.4073 | 10.9153 | 0.4688 | 31.4073 | 10.9153 | 0.4688 |
| DD[18] | 0.7974 | 2.1403 | 4.0587 | 0.7974 | 2.1403 | 4.0587 |
| DD[23] | 0.9259 | 2.9867 | 0.8879 | 1.2745 | 4.9972 | 13.8435 |
| DD[26] | 6.6859 | 21.2028 | 32.0502 | 6.3373 | 19.1923 | 19.0946 |

TABLE 21
Example 7

| Sn | 14 | 15 |
|---|---|---|
| KA | 1.172925828959530E+00 | 3.687283158207430E+02 |
| A4 | −2.534670559570290E−06 | 5.674550813681310E−06 |
| A6 | 1.253467153717430E−07 | 1.031481238157420E−07 |
| A8 | −5.410132245843500E−09 | −5.428557306778470E−09 |
| A10 | 2.016073072547860E−10 | 2.489470304142210E−10 |
| A12 | −3.836070155154180E−12 | −5.610802084489190E−12 |
| A14 | 3.976393153703470E−14 | 6.982119182039140E−14 |
| A16 | −2.093948265055220E−16 | −4.845671128740290E−16 |
| A18 | 4.162726341655740E−19 | 1.724071289139920E−18 |
| A20 | 1.572325590378550E−22 | −2.429467145397380E−21 |

| Sn | 22 | 23 |
|---|---|---|
| KA | 6.413603010737960E−01 | −3.176483509038430E+01 |
| A4 | −3.290851281656170E−05 | −9.074784227850670E−06 |
| A6 | 2.146325574612090E−07 | 1.165289070945380E−06 |
| A8 | −4.251077525006160E−09 | −7.357093328853910E−08 |
| A10 | −1.449749273023280E−10 | 2.672654336789640E−09 |
| A12 | 1.093669046552300E−11 | −5.846759043716880E−11 |
| A14 | −2.758517060964480E−13 | 7.736392744565100E−13 |
| A16 | 3.507495894631930E−15 | −6.017318760707320E−15 |
| A18 | −2.246098301916460E−17 | 2.516680448629250E−17 |
| A20 | 5.782158004891850E−20 | −4.310288351747260E−20 |
| Sn | 27 | 28 |
| KA | −9.414072872936870E+01 | −1.032043364363210E+00 |
| A4 | −1.340286610576460E−04 | 6.538210059421420E−06 |
| A6 | 2.227526532089060E−06 | −7.411192791117760E−07 |
| A8 | −1.879735559703900E−08 | 2.443947884085670E−08 |
| A10 | 8.180965885972540E−11 | −3.636661438855190E−10 |
| A12 | 2.629916860741710E−13 | 3.432942209564590E−12 |
| A14 | −6.180377327963210E−15 | −2.112714838371500E−14 |
| A16 | 3.731130000345730E−17 | 8.111314388895710E−17 |
| A18 | −1.047787187113840E−19 | −1.757028581589980E−19 |
| A20 | 1.157806235333030E−22 | 1.631623543629690E−22 |

### Example 8

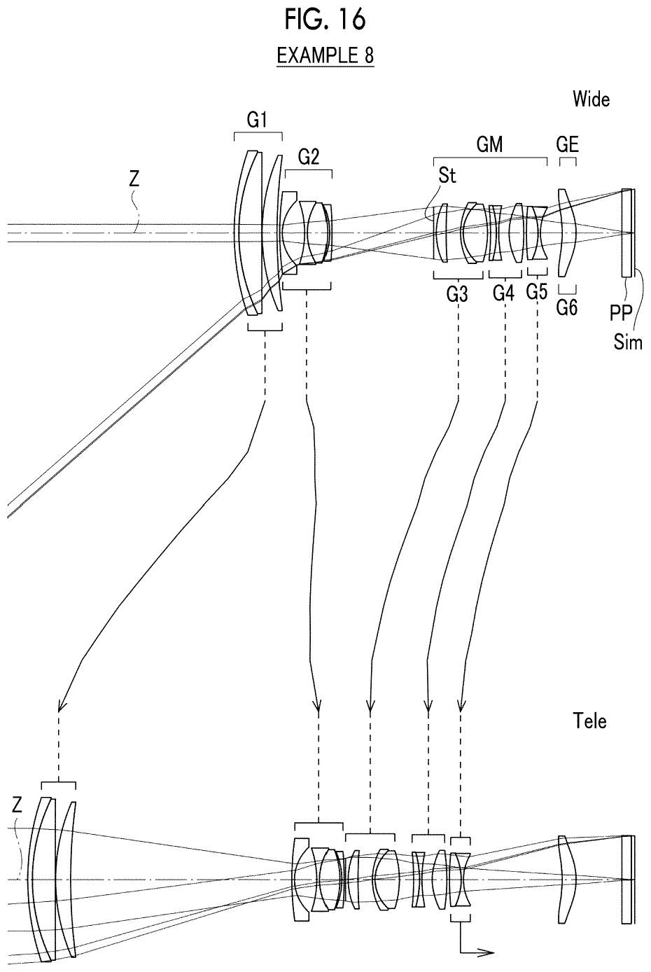

A configuration and a moving trajectory of a variable magnification optical system of Example 8 are shown in FIG. 16. The variable magnification optical system of Example 8 consists of, in order from the object side to the image side, the first lens group G1 having positive refractive power, the second lens group G2 having negative refractive power, the third lens group G3 having positive refractive power, the fourth lens group G4 having positive refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

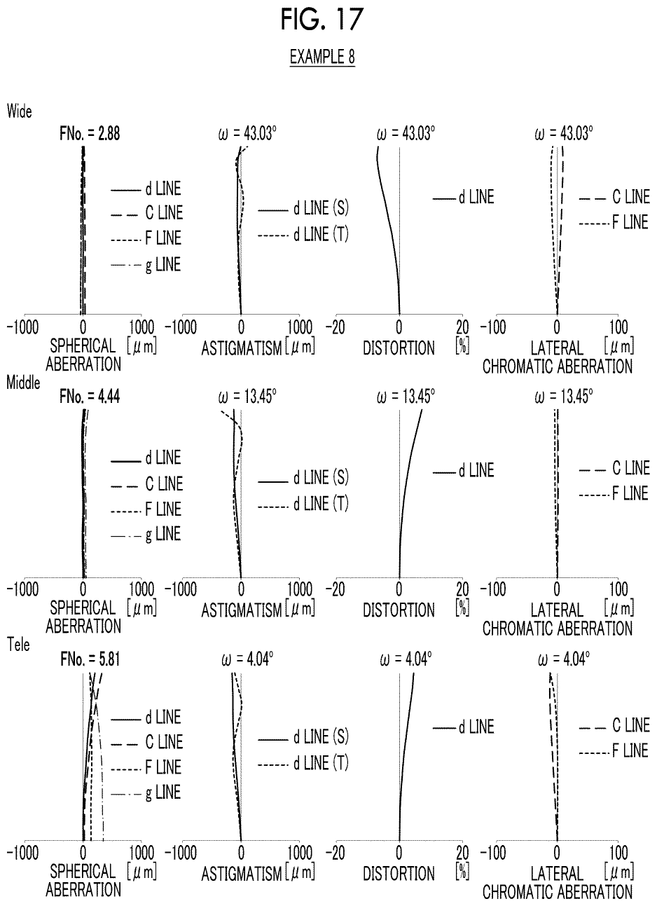

For the variable magnification optical system of Example 8, Table 22 shows basic lens data, Table 23 shows specifications and variable surface spacings, Table 24 shows aspherical coefficients, and FIG. 17 shows each aberration diagram.

TABLE 22
Example 8

| Sn | R | D | Nd | νd | Material | ED |
|---|---|---|---|---|---|---|
| 1 | 87.1112 | 1.4000 | 2.05090 | 26.94 | TAFD65.HOYA | 53 |
| 2 | 62.6890 | 6.9209 | 1.59282 | 68.62 | FCD515.HOYA | 51.96 |
| 3 | 11635.2164 | 0.1000 | | | | 51.69 |
| 4 | 66.9617 | 4.5187 | 1.45650 | 90.27 | H-FK71.CDGM | 50.06 |
| 5 | 199.8168 | DD[5] | | | | 49.49 |
| 6 | 100.0010 | 0.8000 | 1.95375 | 32.32 | TAFD45.HOYA | 26.65 |
| 7 | 14.8416 | 6.7168 | | | | 21.01 |
| 8 | −33.1654 | 0.8259 | 1.59282 | 68.62 | FCD515.HOYA | 20.4 |
| 9 | 19.4784 | 6.0000 | 1.85000 | 27.03 | J-LASFH23.HIKARI | 19.38 |
| 10 | −28.8711 | 0.5891 | | | | 18.77 |
| 11 | −23.8733 | 0.7000 | 1.95375 | 32.32 | TAFD45.HOYA | 18.08 |
| 12 | −118.5024 | DD[12] | | | | 18.19 |
| 13 (St) | ∞ | 0.7992 | | | | 16.73 |
| *14 | 23.8482 | 2.9599 | 1.68948 | 31.02 | L-TIM28.OHARA | 18.5 |
| *15 | 201.9869 | 4.3485 | | | | 18.42 |
| 16 | 21.4154 | 0.8057 | 2.00069 | 25.46 | TAFD40-W.HOYA | 19.17 |
| 17 | 12.8595 | 7.3332 | 1.57144 | 71.61 | FCD615.HOYA | 18.21 |
| 18 | −32.3943 | DD[18] | | | | 18.17 |
| 19 | −85.0439 | 1.7615 | 1.59282 | 68.62 | FCD515.HOYA | 17.49 |
| 20 | −34.8773 | 0.7313 | 1.91082 | 35.25 | TAFD35L.HOYA | 17.31 |
| 21 | 44.4067 | 3.1134 | | | | 17.23 |
| *22 | 19.0097 | 4.4062 | 1.61881 | 63.85 | M-PCD4.HOYA | 18.97 |
| *23 | −65.3720 | DD[23] | | | | 18.8 |
| 24 | 104.0142 | 3.5137 | 1.88252 | 27.00 | H-ZLAF86.NHG | 17.2 |
| 25 | −21.2749 | 0.7000 | 1.88300 | 40.76 | S-LAH58.OHARA | 16.93 |
| 26 | 16.8834 | DD[26] | | | | 16.08 |
| *27 | −41.6665 | 4.2110 | 1.51633 | 64.06 | L-BSL7.OHARA | 26.3 |
| *28 | −21.8702 | 13.8266 | | | | 26.87 |
| 29 | ∞ | 2.8500 | 1.51633 | 64.14 | S-BSL7.OHARA | 28.27 |
| 30 | ∞ | 1.0357 | | | | 28.43 |

TABLE 23
Example 8

| | Object Distance | | | | | |
|---|---|---|---|---|---|---|
| | Infinite | Infinite | Infinite | | | |
| | Distance | Distance | Distance | 0.3 m | 0.2 m | 0.2 m |
| | Magnification State | | | | | |
| | Wide | Middle | Tele | Wide | Middle | Tele |
| Zr | 1.00 | 3.40 | 11.80 | 1.00 | 3.40 | 11.80 |
| f | 16.31 | 55.45 | 192.45 | — | — | — |
| Bf | 16.74 | 16.74 | 16.74 | — | — | — |
| FNo. | 2.88 | 4.44 | 5.81 | 2.88 | 4.43 | 5.66 |
| 2ω [°] | 86.06 | 26.90 | 8.08 | 86.14 | 26.86 | 8.08 |
| DD[5] | 0.8000 | 34.1874 | 66.7998 | 0.8000 | 34.1874 | 66.7998 |
| DD[12] | 30.6853 | 10.9379 | 0.4172 | 30.6853 | 10.9379 | 0.4172 |
| DD[18] | 0.9216 | 2.2347 | 4.3164 | 0.9216 | 2.2347 | 4.3164 |
| DD[23] | 0.8306 | 2.7761 | 0.8129 | 1.1556 | 4.6357 | 13.2633 |
| DD[26] | 6.5611 | 21.2645 | 29.7887 | 6.2361 | 19.4050 | 17.3383 |

TABLE 24
Example 8

| Sn | 14 | 15 |
|---|---|---|
| KA | 1.203769754164560E+00 | 4.016679359825120E+02 |
| A4 | −2.740556050961350E−06 | 2.431177054005000E−06 |
| A6 | 4.702081501471990E−09 | −1.575322366904100E−09 |
| A8 | 6.461182495560730E−09 | 2.287358744837860E−09 |
| A10 | −3.023512075307620E−10 | 1.104310315527000E−11 |
| A12 | 9.546966901487790E−12 | −1.499265801659160E−12 |
| A14 | −1.873128085480080E−13 | 2.868212855443920E−14 |
| A16 | 2.195928504943530E−15 | −2.460981569867170E−16 |
| A18 | −1.398053844716740E−17 | 9.804188790557900E−19 |
| A20 | 3.734965223991650E−20 | −1.467959035659540E−21 |

| Sn | 22 | 23 |
|---|---|---|
| KA | 5.111319318564210E−01 | −5.423641856886320E+00 |
| A4 | −2.646524537323810E−05 | 3.759015026258130E−06 |
| A6 | −7.171437928472460E−07 | −5.244925678106320E−08 |
| A8 | 6.932122773374520E−08 | 2.060418197673850E−08 |
| A10 | −3.502402159303210E−09 | −1.637976677940200E−09 |
| A12 | 1.046225407583300E−10 | 6.228918963956820E−11 |
| A14 | −1.909802702693100E−12 | −1.340365924556580E−12 |
| A16 | 2.081727991257770E−14 | 1.648787351776160E−14 |
| A18 | −1.240077588181990E−16 | −1.077553201433200E−16 |
| A20 | 3.099774295693150E−19 | 2.899145341517420E−19 |
| Sn | 27 | 28 |
| KA | −1.040826681684060E+02 | −8.366770703140050E−01 |
| A4 | −1.350571996672530E−04 | 2.463576400803940E−05 |
| A6 | 2.085268813913030E−06 | −1.652322006450500E−06 |
| A8 | −9.764531079675260E−09 | 5.298406822232270E−08 |
| A10 | −1.632078891028590E−10 | −8.918631480262980E−10 |
| A12 | 3.711015898034770E−12 | 9.243590642669080E−12 |
| A14 | −3.359648308963140E−14 | −5.971292746717580E−14 |
| A16 | 1.622875183488790E−16 | 2.332603340022130E−16 |
| A18 | −4.099954231987350E−19 | −5.038112917308740E−19 |
| A20 | 4.250627910793370E−22 | 4.606914488972570E−22 |

### Example 9

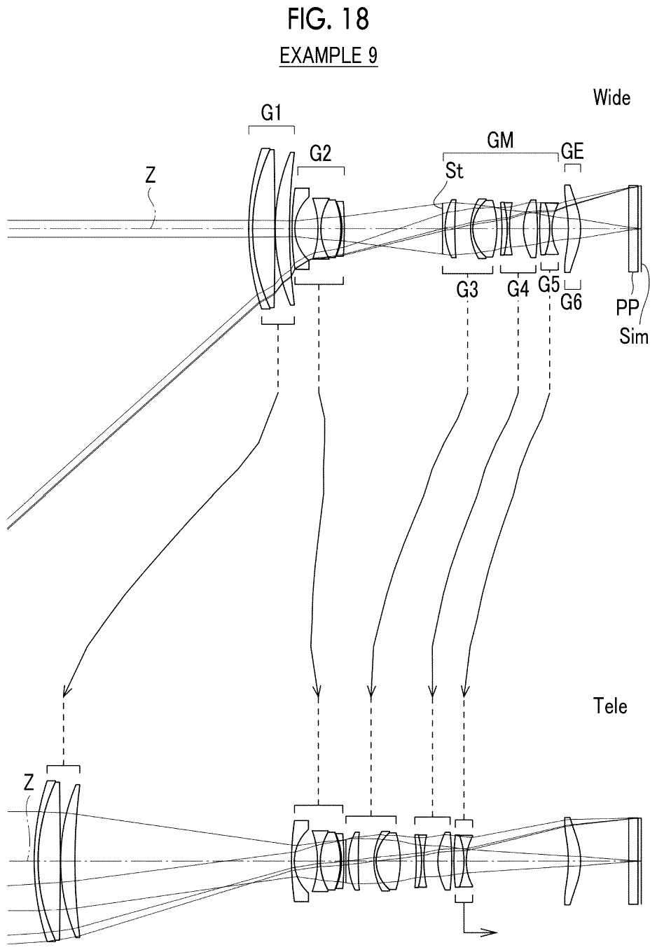

A configuration and a moving trajectory of a variable magnification optical system of Example 9 are shown in FIG. 18. The variable magnification optical system of Example 9 consists of, in order from the object side to the image side, the first lens group G1 having positive refractive power, the second lens group G2 having negative refractive power, the third lens group G3 having positive refractive power, the fourth lens group G4 having positive refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

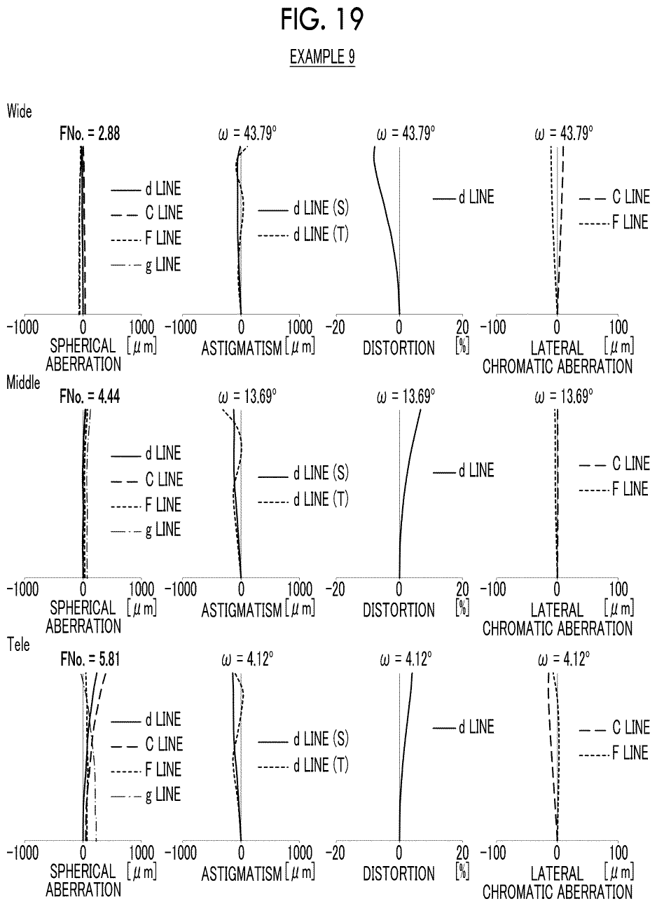

For the variable magnification optical system of Example 9, Table 25 shows basic lens data, Table 26 shows specifications and variable surface spacings, Table 27 shows aspherical coefficients, and FIG. 19 shows each aberration diagram.

TABLE 25
Example 9

| Sn | R | D | Nd | νd | Material | ED |
|---|---|---|---|---|---|---|
| 1 | 89.7582 | 1.1991 | 2.00069 | 25.46 | TAFD40-W.HOYA | 52.97 |
| 2 | 66.4694 | 6.8521 | 1.49700 | 81.61 | FCD1.HOYA | 52.1 |
| 3 | −1412.5295 | 0.1000 | | | | 51.87 |
| 4 | 69.2873 | 4.4073 | 1.55397 | 71.76 | FCD500.HOYA | 50.42 |
| 5 | 207.8924 | DD[5] | | | | 49.89 |
| 6 | 100.0010 | 0.8621 | 1.95375 | 32.32 | TAFD45.HOYA | 26.77 |
| 7 | 14.8400 | 7.1325 | | | | 21 |
| 8 | −31.7528 | 0.8809 | 1.59282 | 68.62 | FCD515.HOYA | 20.05 |
| 9 | 20.3284 | 5.9996 | 1.85000 | 27.03 | J-LASFH23.HIKARI | 19.05 |
| 10 | −26.5718 | 0.3643 | | | | 18.41 |
| 11 | −23.3709 | 0.6998 | 1.95375 | 32.32 | TAFD45.HOYA | 18 |
| 12 | −130.9215 | DD[12] | | | | 18.09 |
| 13 (St) | ∞ | 0.7999 | | | | 16.72 |
| *14 | 23.9489 | 2.9872 | 1.68948 | 31.02 | L-TIM28.OHARA | 18.47 |
| *15 | 206.3904 | 4.8376 | | | | 18.41 |
| 16 | 20.7422 | 0.7005 | 1.95203 | 26.20 | NBFD265.HOYA | 19.15 |
| 17 | 12.6929 | 7.4214 | 1.55032 | 75.50 | FCD705.HOYA | 18.26 |
| 18 | −33.9380 | DD[18] | | | | 18.27 |
| 19 | −85.2874 | 1.6444 | 1.49700 | 81.61 | FCD1.HOYA | 17.11 |
| 20 | −37.5828 | 0.7007 | 1.91650 | 31.60 | S-LAH88.OHARA | 16.95 |
| 21 | 45.2368 | 4.3028 | | | | 16.94 |
| *22 | 18.5651 | 4.2751 | 1.61881 | 63.85 | M-PCD4.HOYA | 19.02 |
| *23 | −89.0935 | DD[23] | | | | 18.82 |
| 24 | 89.7984 | 3.0949 | 1.85451 | 25.15 | NBFD25.HOYA | 17.2 |
| 25 | −26.4268 | 0.7000 | 1.88300 | 40.76 | S-LAH58.OHARA | 16.99 |
| 26 | 18.1997 | DD[26] | | | | 16.39 |
| *27 | −41.6665 | 3.7701 | 1.58660 | 59.01 | K-SKLD200.SUMITA | 27.02 |
| *28 | −23.2488 | 14.8235 | | | | 27.47 |
| 29 | ∞ | 2.8500 | 1.51633 | 64.14 | S-BSL7.OHARA | 28.37 |
| 30 | ∞ | 1.0341 | | | | 28.47 |

TABLE 26
Example 9

| | Object Distance | | | | | |
|---|---|---|---|---|---|---|
| | Infinite | Infinite | Infinite | | | |
| | Distance | Distance | Distance | 0.3 m | 0.2 m | 0.2 m |
| | Magnification State | | | | | |
| | Wide | Middle | Tele | Wide | Middle | Tele |
| Zr | 1.00 | 3.40 | 11.80 | 1.00 | 3.40 | 11.80 |
| f | 16.07 | 54.63 | 189.61 | — | — | — |
| Bf | 17.74 | 17.74 | 17.74 | — | — | — |
| FNo. | 2.88 | 4.44 | 5.81 | 2.87 | 4.42 | 5.58 |
| 2ω [°] | 87.58 | 27.38 | 8.24 | 87.74 | 27.44 | 8.36 |
| DD[5] | 0.8000 | 34.1874 | 66.7998 | 0.8000 | 34.1874 | 66.7998 |
| DD[12] | 30.2910 | 11.0305 | 0.6448 | 30.2910 | 11.0305 | 0.6448 |
| DD[18] | 1.5581 | 2.8712 | 4.9529 | 1.5581 | 2.8712 | 4.9529 |
| DD[23] | 0.7136 | 2.6591 | 0.6959 | 1.0905 | 4.7220 | 14.1145 |
| DD[26] | 5.0526 | 21.4435 | 31.4735 | 4.6757 | 19.3807 | 18.0549 |

TABLE 27
Example 9

| Sn | 14 | 15 |
|---|---|---|
| KA | 1.156724737680460E+00 | 3.941707595625870E+02 |
| A4 | −2.794728070967750E−06 | 2.177497246188650E−06 |
| A6 | 2.325700942648300E−08 | 2.863219211947050E−08 |
| A8 | 4.987605872244720E−09 | 2.444051750100750E−10 |
| A10 | −2.689275703156740E−10 | 3.839808367594800E−11 |
| A12 | 8.564228407987900E−12 | −1.348064184182200E−12 |
| A14 | −1.603012524780530E−13 | 2.039562482369830E−14 |
| A16 | 1.760691630177320E−15 | −1.552296542792780E−16 |
| A18 | −1.046101325779510E−17 | 5.670530372255510E−19 |
| A20 | 2.605698622113220E−20 | −7.878625339649140E−22 |

| Sn | 22 | 23 |
|---|---|---|
| KA | 6.096474911132330E−01 | −3.996939369649410E+00 |
| A4 | −2.531600876472810E−05 | 8.545993378196270E−06 |
| A6 | −1.029756654962900E−06 | −7.628374598963490E−07 |
| A8 | 8.246570133672740E−08 | 7.056011494554900E−08 |
| A10 | −3.744114378064650E−09 | −3.676773030953820E−09 |
| A12 | 1.026372129774120E−10 | 1.117494975239160E−10 |
| A14 | −1.748678151098460E−12 | −2.068895169946530E−12 |
| A16 | 1.806652573441360E−14 | 2.289556031119520E−14 |
| A18 | −1.032154098320350E−16 | −1.386463728443020E−16 |
| A20 | 2.498177752421540E−19 | 3.529155390960230E−19 |
| Sn | 27 | 28 |
| KA | −1.057532265396450E+02 | −5.660725394249680E−01 |
| A4 | −1.473214079759650E−04 | 1.691357976924290E−05 |
| A6 | 2.731186110549390E−06 | −1.007894565263890E−06 |
| A8 | −2.992664703196640E−08 | 3.387579783614070E−08 |
| A10 | 2.156025289264270E−10 | −5.536610109315290E−10 |
| A12 | −7.508181141505710E−13 | 5.539349712435060E−12 |
| A14 | −1.026732312373200E−15 | −3.485781332632960E−14 |
| A16 | 2.017808684398730E−17 | 1.344002429353030E−16 |
| A18 | −7.124052506252900E−20 | −2.903424770784760E−19 |
| A20 | 8.655786377314490E−23 | 2.686036044232070E−22 |

### Example 10

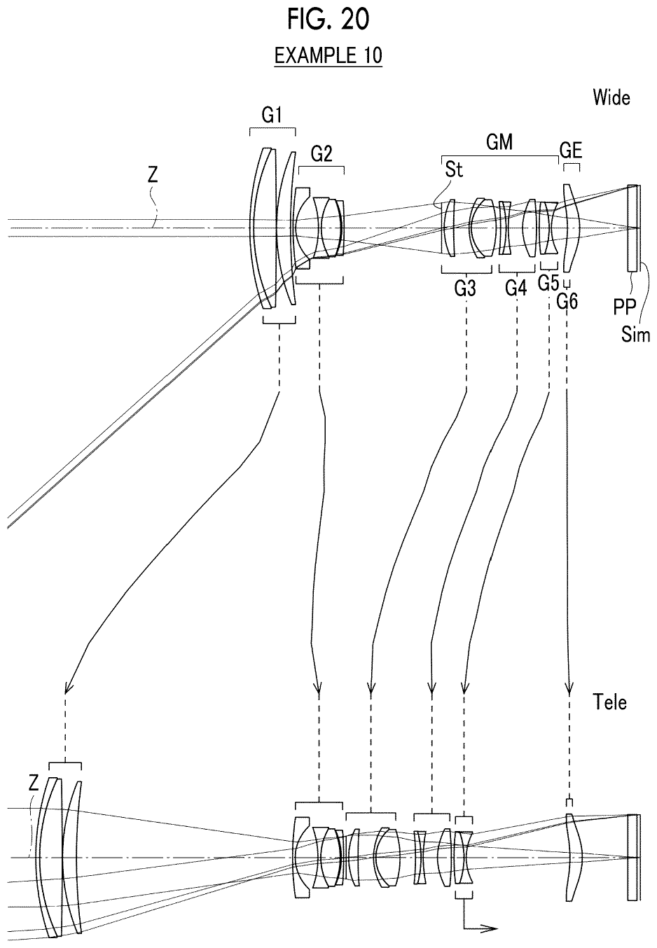

A configuration and a moving trajectory of a variable magnification optical system of Example 10 are shown in FIG. 20. The variable magnification optical system of Example 10 consists of, in order from the object side to the image side, the first lens group G1 having positive refractive power, the second lens group G2 having negative refractive power, the third lens group G3 having positive refractive power, the fourth lens group G4 having positive refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, all lens groups move along the optical axis Z by changing a spacing with respect to an adjacent lens group. The focus group consists of the fifth lens group G5. During focusing from the infinite distance object to the nearby object, the focus group moves to the image side.

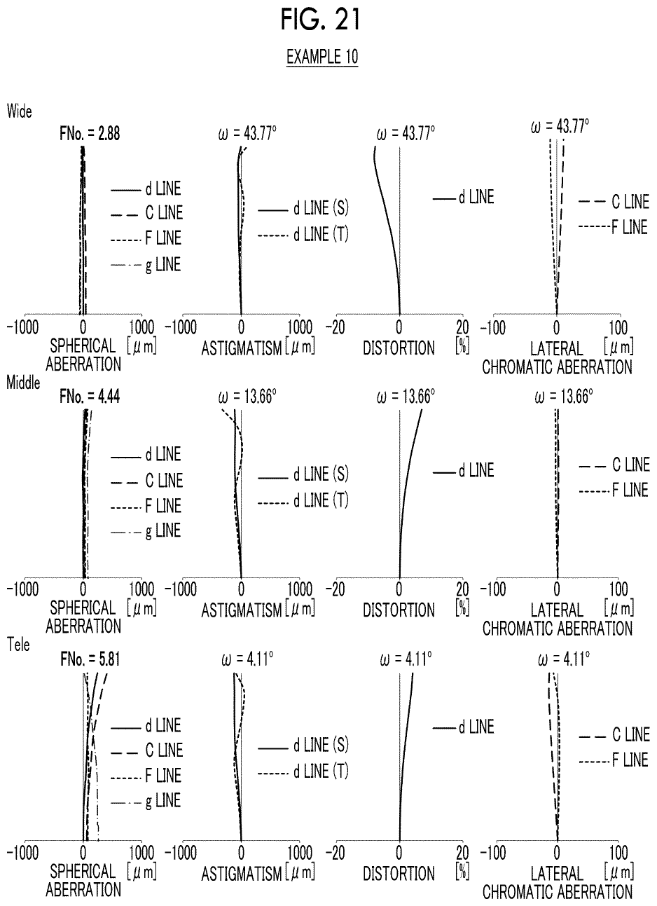

For the variable magnification optical system of Example 10, Table 28 shows basic lens data, Table 29 shows specifications and variable surface spacings, Table 30 shows aspherical coefficients, and FIG. 21 shows each aberration diagram.

TABLE 28
Example 10

| Sn | R | D | Nd | νd | Material | ED |
|---|---|---|---|---|---|---|
| 1 | 87.2969 | 1.2006 | 2.00069 | 25.46 | TAFD40-W.HOYA | 53 |
| 2 | 65.0418 | 6.9924 | 1.49700 | 81.61 | FCD1.HOYA | 52.11 |
| 3 | −1369.1466 | 0.1000 | | | | 51.87 |
| 4 | 70.2702 | 4.3158 | 1.55397 | 71.76 | FCD500.HOYA | 50.39 |
| 5 | 204.3920 | DD[5] | | | | 49.85 |
| 6 | 100.0010 | 0.8217 | 1.95375 | 32.32 | TAFD45.HOYA | 26.66 |
| 7 | 14.8157 | 7.0433 | | | | 20.96 |
| 8 | −31.8099 | 0.8809 | 1.59282 | 68.62 | FCD515.HOYA | 20.06 |
| 9 | 20.2781 | 5.9993 | 1.85000 | 27.03 | J-LASFH23.HIKARI | 19.06 |
| 10 | −26.6407 | 0.3723 | | | | 18.42 |
| 11 | −23.3706 | 0.6991 | 1.95375 | 32.32 | TAFD45.HOYA | 18 |
| 12 | −130.5249 | DD[12] | | | | 18.09 |
| 13 (St) | ∞ | 0.7991 | | | | 16.7 |
| *14 | 24.1315 | 2.9098 | 1.68948 | 31.02 | L-TIM28.OHARA | 18.44 |
| *15 | 205.5795 | 4.7944 | | | | 18.39 |
| 16 | 20.5806 | 0.7000 | 1.95203 | 26.20 | NBFD265.HOYA | 19.18 |
| 17 | 12.7824 | 7.5070 | 1.53775 | 74.70 | S-FPM3.OHARA | 18.3 |
| 18 | −32.3936 | DD[18] | | | | 18.32 |
| 19 | −85.6001 | 1.7062 | 1.49700 | 81.61 | FCD1.HOYA | 17.21 |
| 20 | −36.2136 | 0.6991 | 1.90366 | 31.31 | TAFD25.HOYA | 17.06 |
| 21 | 46.9531 | 4.4108 | | | | 17.05 |
| *22 | 18.7160 | 4.2839 | 1.61881 | 63.85 | M-PCD4.HOYA | 19.04 |
| *23 | −92.8809 | DD[23] | | | | 18.8 |
| 24 | 89.0678 | 3.0774 | 1.85451 | 25.15 | NBFD25.HOYA | 17.2 |
| 25 | −27.1871 | 0.7000 | 1.88300 | 40.76 | S-LAH58.OHARA | 16.99 |
| 26 | 18.2051 | DD[26] | | | | 16.38 |
| *27 | −41.6667 | 3.8119 | 1.58660 | 59.01 | K-SKLD200.SUMITA | 27 |
| *28 | −23.4172 | DD[28] | | | | 27.46 |
| 29 | ∞ | 2.8500 | 1.51633 | 64.14 | S-BSL7.OHARA | 28.36 |
| 30 | ∞ | 1.0354 | | | | 28.46 |

TABLE 29
Example 10

| | Object Distance | | | | | |
|---|---|---|---|---|---|---|
| | Infinite | Infinite | Infinite | | | |
| | Distance | Distance | Distance | 0.3 m | 0.2 m | 0.2 m |
| | Magnification State | | | | | |
| | Wide | Middle | Tele | Wide | Middle | Tele |
| Zr | 1.00 | 3.40 | 11.80 | 1.00 | 3.40 | 11.80 |
| f | 16.07 | 54.64 | 189.65 | — | — | — |
| Bf | 17.83 | 17.68 | 17.02 | — | — | — |
| FNo. | 2.88 | 4.44 | 5.81 | 2.87 | 4.41 | 5.57 |
| 2ω [°] | 87.54 | 27.32 | 8.22 | 87.70 | 27.38 | 8.40 |
| DD[5] | 0.8000 | 34.1874 | 66.7998 | 0.8000 | 34.1874 | 66.7998 |
| DD[12] | 30.2200 | 11.0307 | 0.7856 | 30.2200 | 11.0307 | 0.7856 |
| DD[18] | 1.3898 | 2.7029 | 4.7846 | 1.3898 | 2.7029 | 4.7846 |
| DD[23] | 0.8681 | 2.8136 | 0.8504 | 1.2454 | 4.8732 | 14.1239 |
| DD[26] | 4.9522 | 21.4913 | 31.9679 | 4.5749 | 19.4317 | 18.6943 |
| DD[28] | 14.9109 | 14.7665 | 14.1132 | 14.9109 | 14.7665 | 14.1132 |

TABLE 30
Example 10

| Sn | 14 | 15 |
|---|---|---|
| KA | 1.189625591648210E+00 | 3.958601294283890E+02 |
| A4 | −2.861762526543960E−06 | 2.251013608522530E−06 |
| A6 | 2.414307238635650E−08 | 3.009984365248160E−08 |
| A8 | 5.224501277641350E−09 | 2.606988703952850E−10 |
| A10 | −2.850665910908040E−10 | 4.174750960471290E−11 |
| A12 | 9.186750528902140E−12 | −1.490040977093360E−12 |
| A14 | −1.740057952432940E−13 | 2.292290041524790E−14 |
| A16 | 1.934009752865420E−15 | −1.774224794972550E−16 |
| A18 | −1.162770063665090E−17 | 6.592578966182440E−19 |
| A20 | 2.930807036104370E−20 | −9.321150494053260E−22 |

| Sn | 22 | 23 |
|---|---|---|
| KA | 5.685045452407330E−01 | −8.459397622899090E+00 |
| A4 | −2.624938156285290E−05 | 4.666435861033310E−06 |
| A6 | −7.432952687502200E−07 | −4.183734981439510E−07 |
| A8 | 6.059859930891030E−08 | 4.383525149050690E−08 |
| A10 | −2.813295031360870E−09 | −2.509544409362460E−09 |
| A12 | 7.864264170561400E−11 | 8.077937122898270E−11 |
| A14 | −1.368899949163750E−12 | −1.562904003944810E−12 |
| A16 | 1.448207405288520E−14 | 1.795501699402830E−14 |
| A18 | −8.488391094987440E−17 | −1.124440455136180E−16 |
| A20 | 2.112124449391450E−19 | 2.954904263921340E−19 |
| Sn | 27 | 28 |
| KA | −8.503580609151980E+01 | −8.279556371752110E−01 |
| A4 | −1.187765074298410E−04 | 1.411871803141370E−05 |
| A6 | 1.833361908054210E−06 | −8.668761858183700E−07 |
| A8 | −1.304997236621150E−08 | 2.776448828294080E−08 |
| A10 | 8.831290297573120E−12 | −4.252598135332540E−10 |
| A12 | 8.899566636881880E−13 | 3.963629951163190E−12 |
| A14 | −9.181016328544240E−15 | −2.305765273957670E−14 |
| A16 | 4.403720960375780E−17 | 8.165406450906940E−17 |
| A18 | −1.074214142164600E−19 | −1.616125958382020E−19 |
| A20 | 1.069202635392240E−22 | 1.370216305011100E−22 |

### Example 11

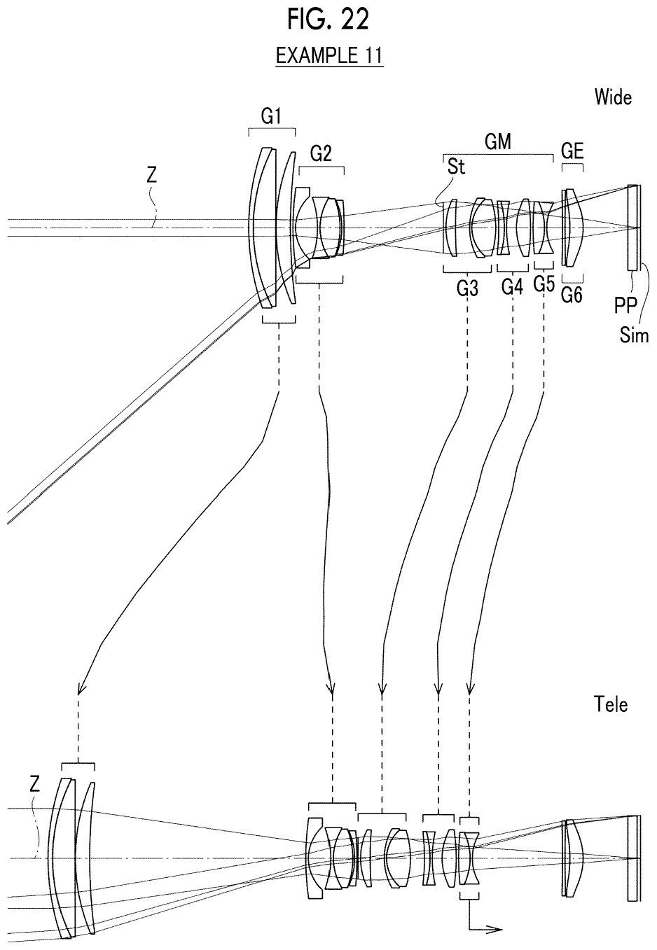

A configuration and a moving trajectory of a variable magnification optical system of Example 11 are shown in FIG. 22. The variable magnification optical system of Example 11 consists of, in order from the object side to the image side, the first lens group G1 having positive refractive power, the second lens group G2 having negative refractive power, the third lens group G3 having positive refractive power, the fourth lens group G4 having positive refractive power, the fifth lens group G5 having negative refractive power, and the sixth lens group G6 having positive refractive power. The intermediate group GM consists of the third lens group G3, the fourth lens group G4, and the fifth lens group G5. The final lens group GE consists of the sixth lens group G6.

During changing the magnification from the wide angle end to the telephoto end, the final lens group GE remains stationary with respect to the image plane Sim, and other lens groups move along the optical axis Z by changing a spacing with respect to an adjacent lens group. The focus group consists of the fifth lens group G5. During focusing from the infinite distance object to the nearby object, the focus group moves to the image side.

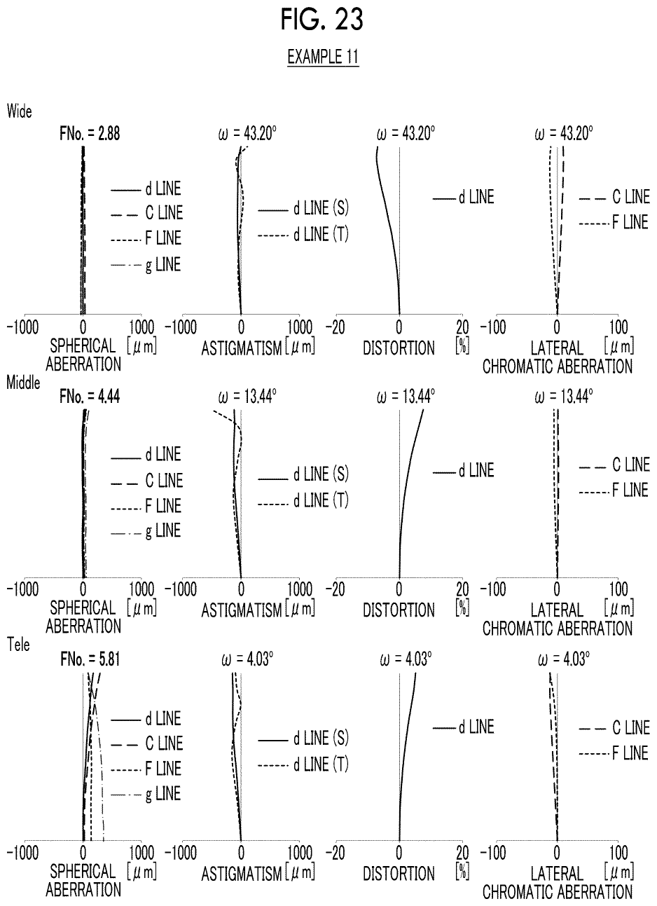

For the variable magnification optical system of Example 11, Table 31 shows basic lens data, Table 32 shows specifications and variable surface spacings, Table 33 shows aspherical coefficients, and FIG. 23 shows each aberration diagram.

TABLE 31
Example 11

| Sn | R | D | Nd | νd | Material | ED |
|---|---|---|---|---|---|---|
| 1 | 85.2965 | 1.3990 | 2.05090 | 26.94 | TAFD65.HOYA | 53 |
| 2 | 61.6609 | 6.9578 | 1.59282 | 68.62 | FCD515.HOYA | 51.93 |
| 3 | 6656.4501 | 0.1000 | | | | 51.66 |
| 4 | 67.8120 | 4.4231 | 1.45650 | 90.27 | H-FK71.CDGM | 50.04 |
| 5 | 198.9599 | DD[5] | | | | 49.48 |
| 6 | 100.0002 | 0.8000 | 1.95375 | 32.32 | TAFD45.HOYA | 26.63 |
| 7 | 14.8124 | 6.7641 | | | | 20.97 |
| 8 | −32.6719 | 0.8108 | 1.59282 | 68.62 | FCD515.HOYA | 20.32 |
| 9 | 19.5116 | 6.0000 | 1.85000 | 27.03 | J-LASFH23.HIKARI | 19.3 |
| 10 | −28.8540 | 0.5567 | | | | 18.68 |
| 11 | −23.8617 | 0.7000 | 1.95375 | 32.32 | TAFD45.HOYA | 18.08 |
| 12 | −115.2045 | DD[12] | | | | 18.19 |
| 13 (St) | ∞ | 0.7998 | | | | 16.72 |
| *14 | 23.7600 | 2.9606 | 1.68948 | 31.02 | L-TIM28.OHARA | 18.49 |
| *15 | 202.0001 | 4.3555 | | | | 18.41 |
| 16 | 21.3976 | 0.7000 | 2.00069 | 25.46 | TAFD40-W.HOYA | 19.11 |
| 17 | 12.8495 | 7.3713 | 1.57144 | 71.61 | FCD615.HOYA | 18.19 |
| 18 | −32.6049 | DD[18] | | | | 18.16 |
| 19 | −85.9118 | 1.7529 | 1.59282 | 68.62 | FCD515.HOYA | 17.47 |
| 20 | −35.2318 | 0.6996 | 1.91082 | 35.25 | TAFD35L.HOYA | 17.3 |
| 21 | 43.9842 | 3.0209 | | | | 17.24 |
| *22 | 19.0246 | 4.3775 | 1.61881 | 63.85 | M-PCD4.HOYA | 18.96 |
| *23 | −63.7456 | DD[23] | | | | 18.8 |
| 24 | 98.3555 | 3.5202 | 1.88252 | 27.00 | H-ZLAF86.NHG | 17.2 |
| 25 | −21.2997 | 0.7000 | 1.88300 | 40.76 | S-LAH58.OHARA | 16.93 |
| 26 | 16.9174 | DD[26] | | | | 16.05 |
| 27 | −500.0018 | 0.8000 | 1.51633 | 64.14 | S-BSL7.OHARA | 24.46 |
| 28 | 499.9961 | 1.5000 | | | | 24.79 |
| *29 | −44.3065 | 4.0940 | 1.51633 | 64.06 | L-BSL7.OHARA | 24.96 |
| *30 | −21.1656 | 13.8347 | | | | 25.59 |
| 31 | ∞ | 2.8500 | 1.51633 | 64.14 | S-BSL7.OHARA | 28.01 |
| 32 | ∞ | 1.0347 | | | | 28.28 |

TABLE 32
Example 11

| | Object Distance | | | | | |
|---|---|---|---|---|---|---|
| | Infinite | Infinite | Infinite | | | |
| | Distance | Distance | Distance | 0.3 m | 0.2 m | 0.2 m |
| | Magnification State | | | | | |
| | Wide | Middle | Tele | Wide | Middle | Tele |
| Zr | 1.00 | 3.40 | 11.80 | 1.00 | 3.40 | 11.80 |
| f | 16.25 | 55.26 | 191.77 | — | — | — |
| Bf | 16.75 | 16.75 | 16.75 | — | — | — |
| FNo. | 2.88 | 4.44 | 5.81 | 2.88 | 4.43 | 5.66 |
| 2ω [°] | 86.40 | 26.88 | 8.06 | 86.48 | 26.86 | 8.08 |
| DD[5] | 0.8000 | 34.1874 | 66.7998 | 0.8000 | 34.1874 | 66.7998 |
| DD[12] | 30.6779 | 10.8260 | 0.3522 | 30.6779 | 10.8260 | 0.3522 |
| DD[18] | 0.9209 | 2.2340 | 4.3157 | 0.9209 | 2.2340 | 4.3157 |
| DD[23] | 0.7772 | 2.7227 | 0.7595 | 1.1004 | 4.5815 | 13.2016 |
| DD[26] | 4.8612 | 19.3505 | 27.8568 | 4.5380 | 17.4917 | 15.4148 |

TABLE 33
Example 11

| Sn | 14 | 15 |
|---|---|---|
| KA | 1.203769754164560E+00 | 4.016679359825120E+02 |
| A4 | −2.740556050961350E−06 | 2.431177054005000E−06 |
| A6 | 4.702081501471990E−09 | −1.575322366904100E−09 |
| A8 | 6.461182495560730E−09 | 2.287358744837860E−09 |
| A10 | −3.023512075307620E−10 | 1.104310315527000E−11 |
| A12 | 9.546966901487790E−12 | −1.499265801659160E−12 |
| A14 | −1.873128085480080E−13 | 2.868212855443920E−14 |
| A16 | 2.195928504943530E−15 | −2.460981569867170E−16 |
| A18 | −1.398053844716740E−17 | 9.804188790557900E−19 |
| A20 | 3.734965223991650E−20 | −1.467959035659540E−21 |

| Sn | 22 | 23 |
|---|---|---|
| KA | 5.111319318564210E−01 | −5.423641856886320E+00 |
| A4 | −2.646524537323810E−05 | 3.759015026258130E−06 |
| A6 | −7.171437928472460E−07 | −5.244925678106320E−08 |
| A8 | 6.932122773374520E−08 | 2.060418197673850E−08 |
| A10 | −3.502402159303210E−09 | −1.637976677940200E−09 |
| A12 | 1.046225407583300E−10 | 6.228918963956820E−11 |
| A14 | −1.909802702693100E−12 | −1.340365924556580E−12 |
| A16 | 2.081727991257770E−14 | 1.648787351776160E−14 |
| A18 | −1.240077588181990E−16 | −1.077553201433200E−16 |
| A20 | 3.099774295693150E−19 | 2.899145341517420E−19 |
| Sn | 29 | 30 |
| KA | −1.279867472396940E+02 | −7.545576094674810E−01 |
| A4 | −1.490418284749990E−04 | 1.300575683366390E−05 |
| A6 | 2.587883405007100E−06 | −1.316168205316490E−06 |
| A8 | −2.688326433622000E−08 | 4.063366740553050E−08 |
| A10 | 2.176090102642030E−10 | −6.133167957964410E−10 |
| A12 | −1.576170718606690E−12 | 5.474103730149340E−12 |
| A14 | 1.280902808650370E−14 | −2.798309459698880E−14 |
| A16 | −8.730430477916930E−17 | 7.144853932218880E−17 |
| A18 | 3.368866830078830E−19 | −4.913017402825260E−20 |
| A20 | −5.246756293595370E−22 | −7.823726258043000E−23 |

Table 34 shows the corresponding values of Conditional Expressions (1) to (18) of the variable magnification optical systems of Examples 1 to 11. Preferable ranges of the conditional expressions may be set using the corresponding values shown in Table 34 as the upper limit values or the lower limit values of the conditional expressions.

TABLE 34

| Expression | | Example | Example | Example | Example | Example | Example |
|---|---|---|---|---|---|---|---|
| Number | | 1 | 2 | 3 | 4 | 5 | 6 |
| (1) | f2/f1 | −0.136 | −0.111 | −0.118 | −0.118 | −0.137 | −0.142 |
| (2) | ZDD1/fw | 3.386 | 7.264 | 6.139 | 6.473 | 4.690 | 4.343 |
| (3) | Nd1 | 1.923 | 1.923 | 1.923 | 1.923 | 2.051 | 2.051 |
| (4) | NdEr | 1.592 | 1.592 | 1.592 | 1.516 | 1.516 | 1.516 |
| (5) | TLw/Bfw | 5.021 | 5.607 | 9.981 | 6.844 | 6.524 | 7.007 |
| (6) | TLt/ft | 2.110 | 1.714 | 1.521 | 1.549 | 1.233 | 1.008 |
| (7) | f1/fE | 1.874 | 1.991 | 1.972 | 1.233 | 1.196 | 1.239 |
| (8) | TLw/fw | 9.695 | 9.669 | 8.888 | 8.837 | 7.497 | 7.549 |
| (9) | Nd1p | 1.593 | 1.593 | 1.593 | 1.593 | 1.593 | 1.550 |
| (10) | fMr/fE | −0.661 | −0.774 | −0.849 | −0.450 | −0.559 | −0.436 |
| (11) | Bfw/fw | 1.931 | 1.725 | 0.890 | 1.291 | 1.149 | 1.077 |
| (12) | ft/fw | 6.200 | 9.882 | 9.882 | 9.882 | 9.882 | 11.800 |
| (13) | fMf/f2 | −1.835 | −1.412 | −1.290 | −1.243 | −1.195 | −1.145 |
| (14) | βT2R/βW2R | 2.488 | 3.574 | 3.071 | 3.360 | 2.629 | 2.688 |
| (15) | βT2/βW2 | 2.492 | 2.765 | 3.218 | 2.941 | 3.759 | 4.390 |
| (16) | TLw/(fw × | 8.628 | 7.972 | 7.335 | 7.408 | 7.691 | 7.774 |
| | tan ωw) | | | | | | |
| (17) | νdn | 20.88 | 20.88 | 20.88 | 20.88 | 26.94 | 26.94 |
| (18) | νdp | 67.02 | 67.02 | 67.02 | 64.06 | 64.06 | 64.06 |

| Expression | | Example | Example | Example | Example | Example |
|---|---|---|---|---|---|---|
| Number | | 7 | 8 | 9 | 10 | 11 |
| (1) | f2/f1 | −0.145 | −0.144 | −0.143 | −0.143 | −0.144 |
| (2) | ZDD1/fw | 3.967 | 3.822 | 4.117 | 4.116 | 3.818 |
| (3) | Nd1 | 2.051 | 2.051 | 2.001 | 2.001 | 2.051 |
| (4) | NdEr | 1.516 | 1.516 | 1.587 | 1.587 | 1.516 |
| (5) | TLw/Bfw | 7.391 | 7.155 | 6.759 | 6.725 | 7.162 |
| (6) | TLt/ft | 0.961 | 0.946 | 0.981 | 0.981 | 0.949 |
| (7) | f1/fE | 1.314 | 1.301 | 1.296 | 1.276 | 1.257 |
| (8) | TLw/fw | 7.377 | 7.345 | 7.461 | 7.459 | 7.381 |
| (9) | Nd1p | 1.571 | 1.593 | 1.497 | 1.497 | 1.593 |
| (10) | fMr/fE | −0.291 | −0.281 | −0.307 | −0.303 | −0.276 |
| (11) | Bfw/fw | 0.998 | 1.027 | 1.104 | 1.109 | 1.031 |
| (12) | ft/fw | 11.800 | 11.800 | 11.800 | 11.800 | 11.800 |
| (13) | fMf/f2 | −1.278 | −1.313 | −1.343 | −1.351 | −1.318 |
| (14) | βT2R/βW2R | 2.585 | 2.457 | 2.549 | 2.545 | 2.458 |
| (15) | βT2/βW2 | 4.565 | 4.803 | 4.630 | 4.636 | 4.800 |
| (16) | TLw/(fw × | 7.788 | 7.867 | 7.782 | 7.786 | 7.860 |
| | tan ωw) | | | | | |
| (17) | νdn | 26.94 | 26.94 | 25.46 | 25.46 | 26.94 |
| (18) | νdp | 64.06 | 64.06 | 59.01 | 59.01 | 64.06 |

In the variable magnification optical systems of Examples 1 to 11, the maximum full angle of view at the wide angle end is 85 degrees or more, and a wide angle of view is achieved. In the variable magnification optical systems of Examples 1 to 11, the zoom ratio is 6× or more, and a high zoom ratio is implemented. The variable magnification optical systems of Examples 1 to 11 achieve high optical performance by favorably correcting various types of aberration in the whole magnification range, while being configured to be reduced in size.

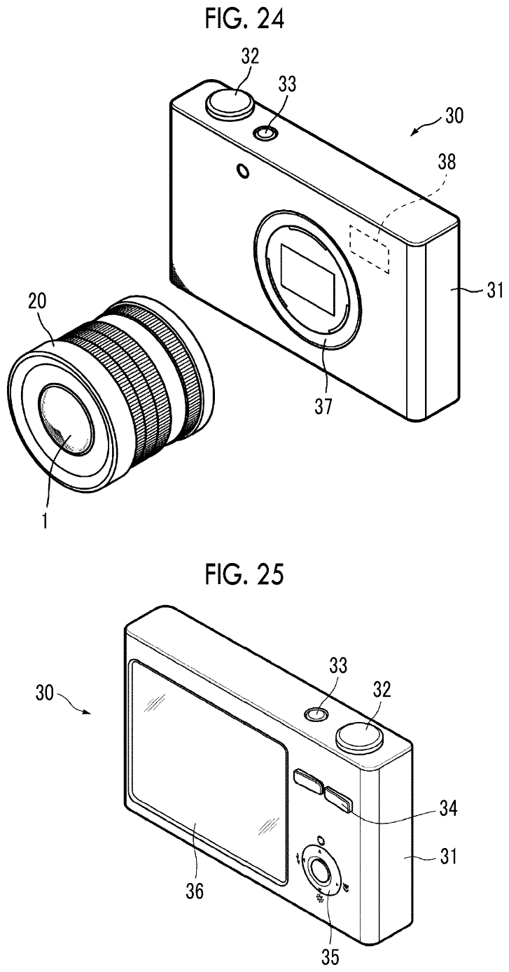

Next, an imaging apparatus according to the embodiment of the present disclosure will be described. FIGS. 24 and 25 show external views of a camera 30 that is the imaging apparatus according to the embodiment of the present disclosure. FIG. 24 shows a perspective view of the camera 30 seen from a front surface side, and FIG. 25 shows a perspective view of the camera 30 seen from a rear surface side. The camera 30 is a digital camera of a so-called mirrorless type on which an interchangeable lens 20 can be attachably and detachably mounted. The interchangeable lens 20 is configured to include a variable magnification optical system 1 according to one embodiment of the present disclosure, accommodated in a lens barrel.

The camera 30 comprises a camera body 31. A shutter button 32 and a power button 33 are provided on an upper surface of the camera body 31. An operator 34, an operator 35, and a display unit 36 are provided on a rear surface of the camera body 31. The display unit 36 can display a captured image and an image within an angle of view before being captured.

An imaging aperture on which light from an imaging target is incident is provided in a center portion of a front surface of the camera body 31. A mount 37 is provided at a position corresponding to the imaging aperture, and the interchangeable lens 20 is mounted on the camera body 31 via the mount 37.

An imaging element 38 is provided in the camera body 31. The imaging element 38 outputs an imaging signal corresponding to a subject image formed by the interchangeable lens 20. For example, a charge coupled device (CCD) or a complementary metal oxide semiconductor (CMOS) is used as the imaging element 38. A signal processing circuit (not shown), a recording medium (not shown), and the like are provided in the camera body 31. The signal processing circuit generates an image by processing the imaging signal output from the imaging element 38. The generated image is recorded on the recording medium. In the camera 30, a still image or a moving image can be captured by pressing the shutter button 32, and image data obtained by this capturing is recorded on the recording medium.

While the disclosed technology is described above using the embodiment and the examples, the disclosed technology is not limited to the embodiment and the examples, and various modifications can be made. For example, the curvature radius, the surface spacing, the refractive index, the Abbe number, and the aspherical coefficients of each lens are not limited to the values shown in each example and may have other values.

The imaging apparatus according to the embodiment of the present disclosure is not limited to the above example and may adopt various aspects such as a camera of a type other than a mirrorless type, a camera composed of an imaging lens and a camera body that are integrated with each other, a film camera, a video camera, a surveillance camera, a broadcasting camera, a movie imaging camera, a factory automation (FA) camera, and a machine vision (MV) camera.

The following appendices are further disclosed with respect to the embodiment and the examples described above.

### Appendix 1

A variable magnification optical system consisting of, in order from an object side to an image side, a first lens group having positive refractive power, a second lens group having negative refractive power, an intermediate group consisting of a plurality of lens groups, and a final lens group having positive refractive power,
in which a front-side intermediate lens group having positive refractive power is disposed closest to the object side in the intermediate group,
a rear-side intermediate lens group having negative refractive power is disposed closest to the image side in the intermediate group,
during changing magnification from a wide angle end to a telephoto end, the first lens group moves to the object side, and all spacings between adjacent lens groups change, and
in a case where a focal length of the first lens group is denoted by f1, and
a focal length of the second lens group is denoted by f2,
Conditional Expression (1) is satisfied, which is represented by

$$- 0.25 < f 2 / f 1 < - 0.05 . \qquad ( 1 )$$

### Appendix 2

The variable magnification optical system according to Appendix 1,
in which the first lens group consists of, in order from the object side to the image side, a negative meniscus lens of which a surface on the object side is a convex surface, a positive lens, and a positive lens.

### Appendix 3

The variable magnification optical system according to Appendix 1 or 2,
in which a positive lens of which a surface on the image side is a convex surface is disposed closest to the image side in the final lens group.

### Appendix 4

The variable magnification optical system according to any one of Appendices 1 to 3,
in which in a case where a difference between a distance on an optical axis from a lens surface closest to the object side in the first lens group to an image plane at the wide angle end and a distance on the optical axis from the lens surface closest to the object side in the first lens group to the image plane at the telephoto end is denoted by ZDD1, and
a focal length of the variable magnification optical system at the wide angle end is denoted by fw,
Conditional Expression (2) is satisfied, which is represented by

$$2 < ZDD 1 / fw < 15. \qquad ( 2 )$$

### Appendix 5

The variable magnification optical system according to any one of Appendices 1 to 4,
in which a negative meniscus lens of which a surface on the object side is a convex surface is disposed closest to the object side in the first lens group, and
in a case where a refractive index at a d line for the negative meniscus lens closest to the object side in the first lens group is denoted by Nd1,
Conditional Expression (3) is satisfied, which is represented by

$$1.7 < Nd 1 < 2.4 . \qquad ( 3 )$$

### Appendix 6

The variable magnification optical system according to Appendix 3,
in which in a case where a refractive index at a d line for the positive lens closest to the image side in the final lens group is denoted by NdEr,
Conditional Expression (4) is satisfied, which is represented by

$$1.43 < NdEr < 1.85 . \qquad ( 4 )$$

### Appendix 7

The variable magnification optical system according to any one of Appendices 1 to 6,
in which in a case where a sum of a distance on an optical axis from a lens surface closest to the object side in the first lens group to a lens surface closest to the image side in the final lens group and a back focus of the variable magnification optical system as an air conversion distance at the wide angle end is denoted by TLw, and
the back focus of the variable magnification optical system as the air conversion distance at the wide angle end is denoted by Bfw,
Conditional Expression (5) is satisfied, which is represented by

$$4 < TLw / Bfw < 12. \qquad ( 5 )$$

### Appendix 8

The variable magnification optical system according to any one of Appendices 1 to 7,
in which in a case where a sum of a distance on an optical axis from a lens surface closest to the object side in the first lens group to a lens surface closest to the image side in the final lens group and a back focus of the variable magnification optical system as an air conversion distance at the telephoto end is denoted by TLt, and
a focal length of the variable magnification optical system at the telephoto end is denoted by ft,
Conditional Expression (6) is satisfied, which is represented by

$$0.85 < TLt / ft < 3. \qquad ( 6 )$$

### Appendix 9

The variable magnification optical system according to any one of Appendices 1 to 8,
in which in a case where a focal length of the final lens group is denoted by fE,
Conditional Expression (7) is satisfied, which is represented by

$$0.9 < f 1 / fE < 3. \qquad ( 7 )$$

### Appendix 10

The variable magnification optical system according to any one of Appendices 1 to 9,
in which in a case where a sum of a distance on an optical axis from a lens surface closest to the object side in the first lens group to a lens surface closest to the image side in the final lens group and a back focus of the variable magnification optical system as an air conversion distance at the wide angle end is denoted by TLw, and
a focal length of the variable magnification optical system at the wide angle end is denoted by fw,
Conditional Expression (8) is satisfied, which is represented by

$$6 < TLw / fw < 10. \qquad ( 8 )$$

### Appendix 11

The variable magnification optical system according to any one of Appendices 1 to 10,
in which in a case where a refractive index at a d line for a positive lens closest to the object side among positive lenses included in the first lens group is denoted by Nd1p,
Conditional Expression (9) is satisfied, which is represented by

$$1. 43 < Nd 1 p < 1.72 . \qquad ( 9 )$$

### Appendix 12

The variable magnification optical system according to Appendix 3,
in which the positive lens closest to the image side in the final lens group is a meniscus lens.

### Appendix 13

The variable magnification optical system according to any one of Appendices 1 to 12,
in which during changing the magnification, the final lens group remains stationary with respect to an image plane.

### Appendix 14

The variable magnification optical system according to any one of Appendices 1 to 13,
in which in a case where a focal length of the rear-side intermediate lens group is denoted by fMr, and
a focal length of the final lens group is denoted by fE,
Conditional Expression (10) is satisfied, which is represented by

$$- 1.5 < fMr / fE < - 0.1 . \qquad ( 10 )$$

### Appendix 15

The variable magnification optical system according to any one of Appendices 1 to 14,
in which in a case where a back focus of the variable magnification optical system as an air conversion distance at the wide angle end is denoted by Bfw, and
a focal length of the variable magnification optical system at the wide angle end is denoted by fw,
Conditional Expression (11) is satisfied, which is represented by

$$0.8 < Bfw / fw < 2. \qquad ( 11 )$$

### Appendix 16

The variable magnification optical system according to any one of Appendices 1 to 15,
in which in a case where a focal length of the variable magnification optical system at the telephoto end is denoted by ft, and
a focal length of the variable magnification optical system at the wide angle end is denoted by fw,
Conditional Expression (12) is satisfied, which is represented by

$$4 < ft / fw < 30. \qquad ( 12 )$$

### Appendix 17

The variable magnification optical system according to any one of Appendices 1 to 16,
in which in a case where a focal length of the front-side intermediate lens group is denoted by fMf,
Conditional Expression (13) is satisfied, which is represented by

$$- 3 < fMf / f 2 < - 0.7 . \qquad ( 13 )$$

### Appendix 18

The variable magnification optical system according to any one of Appendices 1 to 17,
in which in a case where a combined lateral magnification of all groups on the image side with respect to the second lens group in a state where an infinite distance object is in focus at the telephoto end is denoted by βT2R, and
a combined lateral magnification of all groups on the image side with respect to the second lens group in a state where the infinite distance object is in focus at the wide angle end is denoted by βW2R,
Conditional Expression (14) is satisfied, which is represented by

$$1.5 < β T 2 R / β W 2 R < 5. \qquad ( 14 )$$

### Appendix 19

The variable magnification optical system according to any one of Appendices 1 to 18,
in which in a case where a lateral magnification of the second lens group in a state where an infinite distance object is in focus at the telephoto end is denoted by βT2, and
a lateral magnification of the second lens group in a state where the infinite distance object is in focus at the wide angle end is denoted by βW2,
Conditional Expression (15) is satisfied, which is represented by

$$1.5 < β T 2 / β W 2 < 6. \qquad ( 15 )$$

### Appendix 20

An imaging apparatus comprising the variable magnification optical system according to any one of Appendices 1 to 19.

What is claimed is:

1. A variable magnification optical system consisting of, in order from an object side to an image side, a first lens group having positive refractive power, a second lens group having negative refractive power, an intermediate group consisting of a plurality of lens groups, and a final lens group having positive refractive power,
wherein a front-side intermediate lens group having positive refractive power is disposed closest to the object side in the intermediate group,
a rear-side intermediate lens group having negative refractive power is disposed closest to the image side in the intermediate group,
during changing magnification from a wide angle end to a telephoto end, the first lens group moves to the object side, and all spacings between adjacent lens groups change, and
in a case where a focal length of the first lens group is denoted by f1, and
a focal length of the second lens group is denoted by f2,
Conditional Expression (1) is satisfied, which is represented by
$$- 0.25 < f 2 / f 1 < - 0.05 . \qquad ( 1 )$$

2. The variable magnification optical system according to claim 1,
wherein the first lens group consists of, in order from the object side to the image side, a negative meniscus lens of which a surface on the object side is a convex surface, a positive lens, and a positive lens.

3. The variable magnification optical system according to claim 1,
wherein a positive lens of which a surface on the image side is a convex surface is disposed closest to the image side in the final lens group.

4. The variable magnification optical system according to claim 1,
wherein in a case where a difference between a distance on an optical axis from a lens surface closest to the object side in the first lens group to an image plane at the wide angle end and a distance on the optical axis from the lens surface closest to the object side in the first lens group to the image plane at the telephoto end is denoted by ZDD1, and
a focal length of the variable magnification optical system at the wide angle end is denoted by fw,
Conditional Expression (2) is satisfied, which is represented by
$$2 < ZDD 1 / fw < 15. \qquad ( 2 )$$

5. The variable magnification optical system according to claim 1,
wherein a negative meniscus lens of which a surface on the object side is a convex surface is disposed closest to the object side in the first lens group, and
in a case where a refractive index at a d line for the negative meniscus lens closest to the object side in the first lens group is denoted by Nd1,
Conditional Expression (3) is satisfied, which is represented by
$$1.7 < Nd 1 < 2.4 . \qquad ( 3 )$$

6. The variable magnification optical system according to claim 3,
wherein in a case where a refractive index at a d line for the positive lens closest to the image side in the final lens group is denoted by NdEr,
Conditional Expression (4) is satisfied, which is represented by
$$1.43 < NdEr < 1.85 ( 4 ) . \qquad ( 4 )$$

7. The variable magnification optical system according to claim 1,
wherein in a case where a sum of a distance on an optical axis from a lens surface closest to the object side in the first lens group to a lens surface closest to the image side in the final lens group and a back focus of the variable magnification optical system as an air conversion distance at the wide angle end is denoted by TLw, and
the back focus of the variable magnification optical system as the air conversion distance at the wide angle end is denoted by Bfw,
Conditional Expression (5) is satisfied, which is represented by
$$4 < TLw / Bfw < 12. \qquad ( 5 )$$

8. The variable magnification optical system according to claim 1,
wherein in a case where a sum of a distance on an optical axis from a lens surface closest to the object side in the first lens group to a lens surface closest to the image side in the final lens group and a back focus of the variable magnification optical system as an air conversion distance at the telephoto end is denoted by TLt, and
a focal length of the variable magnification optical system at the telephoto end is denoted by ft,
Conditional Expression (6) is satisfied, which is represented by
$$0.85 < TLt / f t < 3. \qquad ( 6 )$$

9. The variable magnification optical system according to claim 1,
wherein in a case where a focal length of the final lens group is denoted by fE,
Conditional Expression (7) is satisfied, which is represented by
$$0.9 < f 1 / fE < 3. \qquad ( 7 )$$

10. The variable magnification optical system according to claim 1,
wherein in a case where a sum of a distance on an optical axis from a lens surface closest to the object side in the first lens group to a lens surface closest to the image side in the final lens group and a back focus of the variable magnification optical system as an air conversion distance at the wide angle end is denoted by TLw, and
a focal length of the variable magnification optical system at the wide angle end is denoted by fw,
Conditional Expression (8) is satisfied, which is represented by
$$6 < TLw / fw < 10. \qquad ( 8 )$$

11. The variable magnification optical system according to claim 1,
wherein in a case where a refractive index at a d line for a positive lens closest to the object side among positive lenses included in the first lens group is denoted by Nd1p,
Conditional Expression (9) is satisfied, which is represented by
$$1.43 < Nd 1 p < 1.72 . \qquad ( 9 )$$

12. The variable magnification optical system according to claim 3,
wherein the positive lens closest to the image side in the final lens group is a meniscus lens.

13. The variable magnification optical system according to claim 1,
wherein during changing the magnification, the final lens group remains stationary with respect to an image plane.

14. The variable magnification optical system according to claim 1,
wherein in a case where a focal length of the rear-side intermediate lens group is denoted by fMr, and
a focal length of the final lens group is denoted by fE,
Conditional Expression (10) is satisfied, which is represented by
$$- 1.5 < fMr / fE < - 0.1 . \qquad ( 10 )$$

15. The variable magnification optical system according to claim 1,
wherein in a case where a back focus of the variable magnification optical system as an air conversion distance at the wide angle end is denoted by Bfw, and
a focal length of the variable magnification optical system at the wide angle end is denoted by fw,
Conditional Expression (11) is satisfied, which is represented by
$$0.8 < Bfw / fw < 2. \qquad ( 11 )$$

16. The variable magnification optical system according to claim 1,
wherein in a case where a focal length of the variable magnification optical system at the telephoto end is denoted by ft, and
a focal length of the variable magnification optical system at the wide angle end is denoted by fw,
Conditional Expression (12) is satisfied, which is represented by
$$4 < f t / fw < 30. \qquad ( 12 )$$

17. The variable magnification optical system according to claim 1,
wherein in a case where a focal length of the front-side intermediate lens group is denoted by fMf,
Conditional Expression (13) is satisfied, which is represented by
$$- 3 < fMf / f 2 < - 0.7 . \qquad ( 13 )$$

18. The variable magnification optical system according to claim 1,
wherein in a case where a combined lateral magnification of all groups on the image side with respect to the second lens group in a state where an infinite distance object is in focus at the telephoto end is denoted by βT2R, and
a combined lateral magnification of all groups on the image side with respect to the second lens group in a state where the infinite distance object is in focus at the wide angle end is denoted by βW2R,
Conditional Expression (14) is satisfied, which is represented by
$$1. 5 < β T 2 R / β W 2 R < 5. \qquad ( 14 )$$

19. The variable magnification optical system according to claim 1,
wherein in a case where a lateral magnification of the second lens group in a state where an infinite distance object is in focus at the telephoto end is denoted by βT2, and
a lateral magnification of the second lens group in a state where the infinite distance object is in focus at the wide angle end is denoted by βW2,
Conditional Expression (15) is satisfied, which is represented by
$$1. 5 < β T 2 / β W 2 < 6. \qquad ( 15 )$$

20. An imaging apparatus comprising:
the variable magnification optical system according to claim 1.
